(19) United States
(12) Patent Application Publication
(10) Pub. No.: US 2020/0315168 A1
(43) Pub. Date: Oct. 8, 2020

(54) Aroma-Loaded Microcapsules with Antibacterial Activity for Eco-friendly Applications

(71) Applicants: The American University in Cairo, New York, NY (US); Universidade do Porto, Porto (PT); Instituto Politécnino de Braganca, Braganca (PT)

(72) Inventors: Asma Mohamad Abdallah Sharkawy, Cairo (EG); tamer Shoeib, New Cairo (EG); Alirio Egidio Rodrigues, Porto (PT); Maria Filomena Filipe Barreiro, Braganca (PT); Isabel Patrícia Martins Fernandes, Braganca (PT)

(21) Appl. No.: 16/496,574

(22) PCT Filed: Mar. 26, 2018
(86) PCT No.: PCT/US2018/024258

§ 371 Date: Sep. 23, 2019

Related U.S. Application Data
(60) Provisional application No. 62/476,821, filed on Mar. 26, 2017.

(51) Int. Cl. A01N 25/28; A01N 25/08; A01N 27/00; A01N 31/16; B01J 13/10; B01J 13/20; C11B 9/00; C11D 3/50; C11D 3/48; D06M 13/00; D06M 13/07; D06M 13/13; D06M 13/192; D06M 15/03; D06M 16/00; D06M 23/12

(52) U.S. Cl. CPC A01N 25/28; D06M 2101/06; A01N 27/00; A01N 31/16; B01J 13/10; B01J 13/206; C11B 9/0061; C11B 9/0034; C11D 3/505; C11D 3/48; D06M 13/005; D06M 13/07; D06M 13/13; D06M 13/192; D06M 15/03; D06M 16/00; D06M 23/12; D06M 2400/01; A01N 25/08

(57) ABSTRACT

Fragrant and antimicrobial properties were conferred to cotton fabrics following microencapsulation using green materials. Limonene and vanillin microcapsules were produced by complex coacervation using chitosan/gum Arabic as shell materials and tannic acid as hardening agent. The effect of two emulsifiers; Span 85 and polyglycerol polyricinoleate (PGPR), on the encapsulation efficiency (EE %), microcapsule's size and morphology, and cumulative release profiles was studied. The use of Span 85 resulted in mononuclear morphology while PGPR gave rise to polynuclear structures, regardless of the core material (vanillin or limonene). The obtained microcapsules demonstrated a sustained release patter. Grafting of the produced microcapsules onto cotton fabrics through an esterification reaction using citric acid as anon-toxic cross-linker followed by thermofixation and curing, was confirmed by SEM and FTIR spectroscopy. Standard antibacterial assays conducted on both microcapsules alone and impregnated onto the fabrics indicated a sustained antibacterial activity.

### FIELD OF THE INVENTION

The invention relates to aroma-loaded microcapsules with antibacterial activity.

### BACKGROUND OF THE INVENTION

Fabrics of natural origins, such as cotton, are known to be more susceptible to colonization by microbes than synthetic ones. This is due to their high hydrophilic and porous composition which retains humidity, nutrients, and oxygen, and is indeed considered as an ideal environment for the growth of microorganisms. Consequently, these microorganisms result in unpleasant odors, transmission of diseases and allergic responses in some individuals. Nowadays manufacturers are increasingly interested in green chemistry protocols, taking into account the growing public awareness of the importance of the utilization of safe and eco-friendly materials and processes. However, the majority of the commercially available microcapsules that are intended for textile applications are made of melamine-formaldehyde, urea-formaldehyde or phenol-formaldehyde resins. These materials represent a serious threat for the environment and human health. This is due to their being non-recyclable thermosetting polymers, and also due to the carcinogenicity and toxicity of formaldehyde. Thus, the replacement of such resins with safe and environmentally benign materials has become extremely important. Thus, it would be an advance in the art to impart fragrant and antibacterial properties to cotton fabrics using safe and environmentally-friendly materials.

### SUMMARY OF THE INVENTION

With the present invention, the inventors demonstrate production of green microcapsules with fragrant and antibacterial properties and their application onto for example, but not limited to, textile substrate using eco-friendly materials. Other applications are onto tissue paper and similar disposables. The microcapsules were synthesized of natural and natural-identical materials. No toxic materials were used in their formulation. The process of fixing the microcapsules to cotton fabrics was also done by using a non-toxic material (citric acid). The formulated microcapsules and the treated fabrics both exhibited sustained antibacterial activity when they were evaluated by the standard antibacterial assays.

To summarize, we provide methods of microcapsule formulation and their grafting onto cotton textiles for two different microcapsule formulations, one using Span 85 as an emulsifier and one using PGPR (polyglycerol polyricinoleate). Both formulations encapsulated Limonene and Vanillin and were grafted onto cotton textiles by esterification using citric acid, thermo-fixation and then curing. Preliminary anti-bacterial assays were carried out for the free microcapsules and the grafted ones. Other molecules than Limonene and Vanillin providing aromas could be encapsulated as well and the invention is not limited to Limonene and Vanillin.

Several significant advantages are provided.

1) The produced limonene and vanillin microcapsules have shown high encapsulation efficiencies (ranged between 90.4% and 100%). This was accomplished by using entirely green materials, such as gum Arabic and chitosan as shell materials and tannic acid, as the hardening agent. To our knowledge, this is the first successful encapsulation of the cargo using this method; as the available literature on complex coacervation to date did not refer to the encapsulation of limonene and vanillin (in pure form and not vanilla oil) by the usage of chitosan and gum Arabic as the wall material pair.

2) The produced microcapsules demonstrated a considerable controlled release patterns and a sustained antibacterial activity against Escherichia coli and Staphylococcus aureus; which would make their use appropriate for many applications (e.g. food formulations, cosmetics and textile applications).

3) The grafting process of the microcapsules to the cotton substrate was done by a chemical reaction using a non-toxic material (citric acid); which provided a green as well as a durable fragrant and antibacterial finishing to the fabric.

Embodiments of the invention have numerous applications.

1) The treated cotton fabrics can be used in hospitals for patients and surgical uniforms, white coats, hospital bed sheets and towels to replace the conventional cotton fabrics and guard against nosocomial infections.

2) The treated fabrics can be also incorporated into diapers, sanitary pads and wound bandages. They are also suitable for use in aromatherapy.

3) The produced microcapsules exhibited a controlled release profile and sustained antibacterial activity. They were also formulated of Generally Recognized as Safe (GRAS) materials, and thus they can be incorporated safely in other applications, such as food and cosmetics (not just textile applications); to release the vanillin/limonene in a controlled manner and also enhance the shelf-life of the product.

4) Anti-bacterial textiles. For sports and health-care related clothing, or using the free microcapsules in detergents and fabric softeners. This is more favorable for the capsules that provide longer aroma release profiles.

5) Food applications. This is more favorable for the capsules with instant/short aroma release profiles.

In an experimental demonstration of principles relating to this work, fragrant and antimicrobial properties were conferred to cotton fabrics following microencapsulation using green materials. Limonene and vanillin microcapsules were produced using chitosan/gum Arabic as shell materials and tannic acid as hardening agent. The mean diameter of the produced microcapsules ranged between 10.4 μm and 39.0 μm, whereas EE % was found to be between 90.4% and 100%. The use of Span 85 resulted in mononuclear morphology while PGPR gave rise to polynuclear structures, regardless of the core material (vanillin or limonene). The obtained microcapsules demonstrated a sustained release pattern; namely the total cumulative release of the active agents after 7 days at 37±1° C. was 75%, 52% and 19.4% for the polynuclear limonene microcapsules, the mononuclear limonene microcapsules and the polynuclear vanillin microcapsules, respectively. Grafting of the produced microcapsules onto cotton fabrics through an esterification reaction using citric acid as a non-toxic cross-linker followed by thermofixation and curing, was confirmed by SEM and ATR-FTIR spectroscopy. Standard antibacterial assays conducted on both microcapsules alone and impregnated onto the fabrics indicated a sustained antibacterial activity.

### BRIEF DESCRIPTION OF THE DRAWINGS

FIGS. 1A-D show according to an exemplary embodiment of the invention optical microscope images of vanillin microcapsules of (FIG. 1A) formulation 1 produced by PGPR and (FIG. 1B) formulation 3 produced by Span 85 (Magnification (FIG. 1A) 200× and (FIG. 1B) 400×); limonene microcapsules of (FIG. 1C) formulation 4 produced by PGPR and (FIG. 1D) formulation 6 produced by Span 85 (Magnification (FIG. 1C) 400× and (FIG. 1D) 1000×).

FIG. 2 shows according to an exemplary embodiment of the invention cumulative release profiles of (A) vanillin in formulation 2 (PGPR), (B) limonene in formulation 4 (PGPR) and (C) limonene in formulation 6 (Span 85). Samples were incubated in n-hexane at 37° C. and 100 rpm.

FIGS. 3A-B show according to an exemplary embodiment of the invention SEM images of fabrics impregnated with FIG. 3A) vanillin microcapsules of formulation 1 cured at 120° C. for 3 minutes and FIG. 3B) vanillin microcapsules of formulation 1 cured at 150° C. for 2 minutes.

FIGS. 4A-B show according to an exemplary embodiment of the invention SEM images of fabrics impregnated with (FIG. 4A) vanillin microcapsules of formulation 2 and (FIG. 4B) limonene microcapsules of formulation 5, both cured at 120° C. for 3 minutes.

FIGS. 5A-D show according to an exemplary embodiment of the invention FTIR spectra of: FIG. 5A) microcapsules; FIG. 5B) citric acid; FIG. 5C) untreated cotton fabric and FIG. 5D) cotton fabric treated with limonene microcapsules.

FIGS. 6A-F show according to an exemplary embodiment of the invention zones of inhibition after 24 hours of incubation of: FIG. 6A) non-encapsulated vanillin and FIG. 6B) encapsulated vanillin against S. aureus; FIG. 6C) non-encapsulated limonene in DMSO and FIG. 6D) encapsulated limoene against S. aureus; FIG. 6E) non-encapsulated vanillin and FIG. 6F) encapsulated vanillin against E. coli.

FIGS. 7A-B show according to an exemplary embodiment of the invention differential particle size distribution (curve 710) and cumulative particle size distribution (curve 720) of FIG. 7A) vanillin microcapsules of formulation 1 (mean diameter=15.7 μm), and FIG. 7B) limonene microcapsules of formulation 4 (mean diameter=18.4 μm). Both formulations were prepared with the same amount of PGPR

FIGS. 8A-B show according to an exemplary embodiment of the invention differential particle size distribution (curve 810) and cumulative particle size distribution (curve 820) of FIG. 8A) vanillin microcapsules of formulation 2 (mean diameter=38.3 μm) and FIG. 8B) limonene microcapsules of formulation 5 (mean diameter=39.0 μm). Both formulations were prepared with the same amount of PGPR

FIGS. 9A-B show according to an exemplary embodiment of the invention differential particle size distribution (curve 910) and cumulative particle size distribution (curve 920) of FIG. 9A) vanillin microcapsules of formulation 3 (mean diameter=10.4 μm) and FIG. 9B) limonene microcapsules of formulation 6 (mean diameter=11.1 μm). Both formulations were prepared with the same amount of Span 85.

FIG. 10 shows according to an exemplary embodiment of the invention SEM image of fabric impregnated with limonene microcapsules of formulation 4 cured at 120° C. for 3 minutes.

FIGS. 11A-B show according to an exemplary embodiment of the invention SEM images of fabrics impregnated with FIG. 11A) Vanillin microcapsules of formulation 3 and FIG. 11B) limonene microcapsules of formulation 6; showing remnants of microcapsules. Both formulations were prepared by Span 85.

FIG. 12 shows according to an exemplary embodiment of the invention SEM images of cotton fabrics impregnated with limonene microcapsules (formulation 5) after being washed with 2% commercial soap and 0.1N acetic acid.

FIGS. 13A-B show according to an exemplary embodiment of the invention GC-FID chromatograms of FIG. 13A) vanillin in one of the dilutions of the calibration curve, FIG. 13B) non-encapsulated vanillin in one of the measurements of the EE %.

FIGS. 14A-B show according to an exemplary embodiment of the invention GC-FID chromatograms of FIG. 14A) limonene in one of the dilutions of the calibration curve, FIG. 14B) non-encapsulated limonene in one of the measurements of the EE %.

### DETAILED DESCRIPTION

### 1. Introduction

The increase in the market competitiveness along with the diversity of consumers' demands has created a challenging environment in the textile industry sector. This subsequently led to the production of innovative textile products with advanced properties that enhance ergonomics, health and safety.¹ Innovative technologies in textiles have succeeded in offering a wide variety of fabrics with unprecedented functions.^{2,3} The most common applications of functional textiles include the use of phase change materials, insect repellents, antimicrobials, fragrances, dyes and colorants, skin softeners and moisturizers, some medicines, and flame retardants.^{2,4-10}

Enhancing the durability and prolonging the lifetime of functional textiles have been always one of the most challenging missions for textiles' manufacturers; owing to the fact that they are non-disposable and need to be washed after use. In this context, microencapsulation techniques have been known to provide textiles with long-lasting properties and added value.¹¹ The process involves the coating of the active ingredient with one or more polymeric materials to form particles whose size range between 1 μm and 1000 μm.^{12,13} According to their internal structure,¹⁴ microcapsules can be classified into two main types either reservoir or monolithic. Reservoir microcapsules can be either mononuclear or polynuclear (multinuclear), whereas the monolithic microcapsules are formed of a matrix with the active ingredient dispersed within it.¹¹ Each microcapsule acts as a minute reservoir for the active ingredient which would be released under specific conditions.¹⁵ This process thus, remarkably increases the durability and long lastingness of the effect of the functional ingredient incorporated onto these textiles.

Nowadays, researchers and manufacturers are increasingly interested in green chemistry protocols, taking into account the growing public concern and awareness of the importance of the utilization and application of safe and eco-friendly materials and processes. However, the majority of the commercially available microcapsules that are intended for textile applications are made of melamine-formaldehyde, urea-formaldehyde or phenol-formaldehyde resins.^{16,17} Regardless of the fact that these polymers are used because of their good thermal stabilities and their ability to be modified according to the desired release profiles, they represent a serious threat for the environment and human health. This is due to their non-recyclable nature (thermosetting polymers), and also owing to the carcinogenicity and toxicity of formaldehyde.¹⁸ Thus, the replacement of such polymeric systems with safe and environmentally benign materials has become extremely important.¹⁹ Natural and natural-derived polymers, especially those presenting biocompatibility and biodegradability characteristics, are increasingly becoming promising alternatives to synthetic polymers; as they are known to be eco-friendly, abundant, and safe to human health.^{20,21}

Complex coacervation is considered as one of the most suitable methods to encapsulate fragrances and flavors; it reduces or prevents the loss of the volatile compounds since it does not require high processing temperatures.²² It is a phase separation process that depends on the complexation between oppositely charged polymers via electrostatic attractions, formation of hydrogen bonds or hydrophobic interactions.²³ To increase microcapsules' integrity, a hardening agent is usually added in the last step of the coacervation process to consolidate the formed shells and stabilize their structure.²⁴ Formaldehyde and glutaraldehyde are widely used, but since they are reported to be toxic they became banned in some countries.²⁵ Therefore, the use of safe and eco-friendly alternatives has gained significant importance to substitute these conventional cross-linking agents. This is the case of tannic acid, a natural plant polyphenol, which has the ability to bind to polymers through hydrogen bonding and hydrophobic interactions.²⁶⁻²⁸

The process of fixing the microcapsules onto textile substrates is another critical step in ensuring durability, wash-ability and the effectiveness of the added-value properties of the fabric. The adhesion methods involve the use of two main groups of binders; polymeric resins, with film-forming ability, and polyfunctional cross-linking agents.²⁹ Although film-forming binders provide a three dimensional network that strongly adheres microcapsules to the fabric, they may hinder the release of the encapsulated active agent and reduce the aroma intensity of the used fragrance microcapsules.^{30,31} Therefore, chemical grafting by means of polyfunctional cross-linkers is sometimes preferred. These chemical cross-linkers can be subdivided into formaldehyde based cross-linkers, e.g., formaldehyde and glutaraldehyde, and non-formaldehyde based cross-linkers, such as polycarboxylic acids. Grafting or crosslinking of microcapsules to cotton fabrics via polycarboxylic acids occurs covalently through an esterification reaction between their own carboxylic groups and hydroxyl groups present in the cotton cellulose and/or the polymeric materials of the microcapsules' shell.^{32,33}

Fabrics of natural origins, such as cotton are known to be more susceptible to colonization by invasive microbes than synthetic ones.¹⁹ This is due to their high hydrophilic and porous composition that tends to retain humidity, nutrients, and oxygen, thus offering an ideal environment for the growth of microorganisms.^{19,34} This results in unpleasant odors, diseases transmission and allergic responses in some individuals. Additionally, deterioration of fabrics in terms of color degradation, loss of elasticity and tensile strength, and interference with the dyeing and printing processes can occur.¹⁹ Hence, it is crucial to combat these undesired effects through imparting effective antimicrobial additives to textiles.^{35,36}

In this context, vanillin encapsulated in a polysulfone polymer and incorporated onto cotton fabrics was reported to provide the fabrics with durable aromatic properties and antibacterial activity.³ Rodrigues and coworkers used interfacial polymerization technology to encapsulate limonene in polyurethane-urea microcapsules for the purpose of producing durable fragrant fabrics.³⁷ Sundrarajan also reported the preparation of limonene/gum Arabic microcapsules for textile application.³⁶

In this invention, the microencapsulation of vanillin and limonene by the complex coacervation method using chitosan/gum Arabic as encapsulants and tannic acid as the hardening agent was studied. To our knowledge, this is the first successful encapsulation of the cargo using this method; as the available literature on complex coacervation to date did not refer to the encapsulation of limonene and vanillin (in pure form and not vanilla oil) by the usage of chitosan and gum Arabic as the wall material pair. The impact of two emulsifiers (Span 85 and polyglycerol polyricinoleate (PGPR)) on the encapsulation efficiency and microcapsules' size and morphology was studied together with the characterization of the cumulative release profiles of limonene and vanillin. A strategy to achieve the immobilization of the produced limonene and vanillin microcapsules on cotton fabrics by using citric acid, an-ecofriendly cross-linker, was developed and the antibacterial activity of the microcapsules alone and impregnated onto the fabric was evaluated.

### 2. Experimental

### 2.1. Materials

Chitosan (Degree of deacetylation 88-95% and molecular weight between 80,000 and 200,000 Da) and gum Arabic were used as shell-forming materials. Vanillin and limonene, used as core agents, were purchased from Sigma Aldrich. Pure corn oil, used as carrier for vanillin, was obtained from Sigma Aldrich. Polyglycerol polyricinoleate (PGPR 4150) was a gift from Palsgaard® (Denmark), and Span 85 was supplied from Sigma Aldrich. Tannic acid was supplied by Merck. 0.1N acetic acid, used to dissolve chitosan, was purchased from Sigma Aldrich. n-hexane, used as the microcapsules' washing medium and in the release studies, was supplied from Carlo Erba Reagents. Citric acid and sodium phosphate monobasic monohydrate were purchased from Sigma Aldrich and were used in the chemical grafting reaction. Standard 100% cotton fabric was purchased from SDC Enterprises Limited, UK.

### 2.2. Production of Microcapsules

Microcapsules were prepared by complex coacervation using a four-step process adapted from the literature with some modifications.³⁸ In brief, the first step involved the dissolution of the biopolymers chitosan and gum Arabic. 1% (w/v) chitosan solution was prepared by dissolving chitosan in 0.1N acetic acid and left under magnetic stirring for 15 hours to ensure complete dissolution. 2% (w/v) gum Arabic solution was obtained by dissolving gum Arabic in deionized water with continuous magnetic stirring at 45° C. for 2 hours. In the second step, the polymer solutions (50 ml of the chitosan solution and 50 ml of the gum Arabic solution) were mixed together, then added with a known amount of the core material (either vanillin or limonene) plus emulsifier. The corresponding used quantities, of both the core materials and the emulsifiers, in the six prepared formulations are shown in Table 1.

The mixture was then emulsified at a speed rate of 8000 rpm at 40° C. for 1 minute with an ultraturrax IKA DI 25 Basic. Taking into consideration that vanillin is a solid powder; it was previously dissolved in corn oil at 40° C. in a covered beaker for 10 minutes before being added to the mixture. The third step entailed the induction of complex coacervation by decreasing the pH value with 0.2N HCl and setting the stirring speed of the formed emulsion to 400 rpm. In this study, the pH was adjusted to 3.5 to maximize chitosan positive charge (2.8<pH<4), and gum Arabic negative charge (pH>2.2).³⁸ After 30 minutes of continuous stirring, the temperature was gradually decreased from 40° C. to 5° C. with the help of an ice bath. The last step involved the hardening of the microcapsules by drop wisely adding 2 ml of a 10% (w/v) tannic acid solution at 5° C. and stirring at 400 rpm for 3 hours. The formed microcapsules were then separated by decantation, recovered and stored in the form of a suspension for further analysis.

### 2.3. Characterization of Microcapsules

### 2.3.1. Optical Microscopy

As a routine assay, the morphology of the obtained microcapsules was examined by optical microscopy by using a Leica DM 2000 optical microscope equipped with Leica Application Suite Interactive Measurement imaging software.

### 2.3.2. Particle Size Evaluation

Size distributions and mean particle size of the produced microcapsules were determined by laser diffraction with a Beckman Coulter Laser Diffraction Particle Size Analyzer LS 230. The size distribution measurements were obtained in both volume and number.

### 2.3.3. Encapsulation Efficiency

To determine the encapsulation efficiency, of both vanillin and limonene, the non-encapsulated active agent was evaluated by GC-FID using a Varian CP-3800 gas chromatographer equipped with two CP-Wax 52CB bonded fused silica polar columns (50 m×0.25 mm with 0.2 μm film thickness) and a Varian FID detector operated by the Saturn 2000 WS software. The used method comprised setting the injectors at 240° C., and the FID detector at 250° C. The carrier gas was helium He N60 with a flow rate of 1 mL/min and a split ratio of 1:50 was used.

For vanillin analysis, the oven temperature was kept isothermal at 50° C. for 5 minutes, and then increased gradually from 50° C. up to 120° C. (rate of 10° C./min), followed by a second gradual increase to 200° C. (rate of 2° C./min). For limonene, the oven temperature was maintained isothermal at 175° C. for 7 minutes, and then increased to 220° C. (rate of 10° C./min) with a hold of 5 minutes. The samples for injection were prepared by taking 2 ml from the whole formulation, then mixed with 1 ml of n-hexane, followed by centrifugation at 3000 rpm for 5 minutes. The collected supernatant was filtered through 0.2 μm pore size polypropylene filter. Thereafter, a volume of 0.1 μL was injected. All measurements were done in triplicate. Quantification was based on previously prepared calibration curves. The encapsulation efficiency (EE %) was calculated according to the following equation:

$$EE \% = \frac{mass ( total ) - mass ( non \text{-} encapsulated )}{mass ( total )} \times 100 \qquad ( 1 )$$

where mass (total) is the mass of the loaded core material in the process in g, and mass (non-encapsulated) is the mass of the non-encapsulated core material, as determined by GC-FID in g.

### 2.3.4. Solid Content Determination

The solid content of the microcapsule's suspension was determined according to the European Standard EN 827, as described for water based adhesives. The test was done by placing about one gram, rigorously weighted, of the microcapsules' suspension on a watch glass (mass (initial)) and allowing it to dry in an oven at 100° C. for 30 minutes, then placing it in a desiccator for 15 minutes and weighing the residual mass. The drying step was repeated until the difference between two consecutive weightings did not exceed 2 mg.⁴¹ This value was considered the final mass (mass (final)). The solid content was calculated according to the following equation:

$$\% Solid Content = \frac{mass ( final )}{mass ( initial )} \times 100 \qquad ( 2 )$$

### 2.4. Cumulative Release Profiles

The used method was adapted from a previously reported study.⁴⁰ Briefly, vanillin and limonene microcapsules suspensions were first washed with deionized water and thereafter with n-hexane in order to remove all the non-encapsulated core material from the microcapsules. Then, volumes of 70 ml of washed microcapsules suspension were placed in sealed bottles containing a 30 ml of n-hexane and placed in an incubator at 37° C. under a mild shaking speed of 100 rpm. At predetermined time intervals, samples (2 ml of the supernatant) were taken out of the incubating chamber, filtered through 0.2 μm pore size polypropylene filter and placed in a sealed vial for GC-FID analysis according to the procedure described in the section 2.3.3. In order to keep the final volume constant, 2 ml of n-hexane was added to the microcapsules' suspension in the sealed bottles to compensate the volume of the sample taken for quantification. Injections were carried out in triplicate. Then the masses of the released active agents were calculated using a mass balance. The cumulative release from the microcapsules suspension for each sampling time was calculated from the following equation:⁴²

$$Cumulative Release ( CR \% ) = \frac{m ( released )}{m ( initial )} \times 100 \qquad ( 3 )$$

where m(released) is the mass of the released limonene or vanillin at a certain sampling time and m(initial) is the initial mass of limonene or vanillin present in the microcapsules.

### 2.5. Grafting of Microcapsules on Fabrics

Citric acid was used as a non-toxic cross-linker to covalently join the wall material (chitosan/gum Arabic coacervates) onto the cotton fabrics by ester bonds. The procedure applied here is based on methods previously reported in the literature^{32,33} but with some modifications. The test fabrics were firstly immersed in a bath containing 10% (w/v) of the microcapsules suspension, 3% (w/v) of citric acid and 1.5% (w/v) of sodium phosphate monobasic monohydrate (used as catalyst). Thereafter it was heated at 50° C. for 5 minutes. Fabrics were then washed thoroughly twice with deionized water and passed through a 2 roller foulard (Roaches EHP Padder) under 1 bar pressure at a speed rate of 3 m/min. Subsequently, fixation was achieved by placing the fabric samples in a thermofixation chamber (Roaches laboratory thermofixation oven, model Mini Thermo) with circulating air at a temperature of 90° C. for 2 minutes. After drying, the curing process was tested at two different conditions (120° C. and 150° C. for three and two minutes, respectively). The wet pick up percentage of the impregnated samples ranged between 95% and 100% and was determined according to the following formula:³⁷

$$Wet pick up \% ( w / w ) = \frac{mass ( wet fabric ) - mass ( dry fabric )}{mass ( dry fabric )} \times 100 \qquad ( 4 )$$

where mass (dry fabric) was the sample mass before the impregnation and mass (wet fabric) was the sample mass after the foulard step, as described previously.

### 2.6. Characterization of Treated Fabrics

### 2.6.1. SEM

A high-resolution (Schottky) Environmental Scanning Electron Microscope with X-Ray Microanalysis and Electron Backscattered Diffraction Analysis: Quanta 400 FEG ESEM/EDAX Genesis X4M operating at 15.00 kV was used to examine the morphological features of the produced microcapsules grafted onto the fabrics. Samples were directly examined without being previously coated.

### 2.6.2. FTIR Spectroscopy

To examine the effectiveness of the grafting reaction, samples of microcapsules, citric acid, untreated cotton fabric (control), and impregnated cotton fabric were examined by FTIR. The microcapsules samples were separated from the original suspension by decantation and then freeze-dried before FTIR analysis. The analysis was conducted using a Jasco FT/IR-6800 spectrometer, (Jasco Analytical Instruments, USA), equipped with a MIRaclem Single Reflection ATR (attenuated total reflectance ZnSe crystal plate) accessory (PIKE Technologies, USA) and a TGS (triglycine sulfate) detector. Cosine apodization function was used to suppress leakage side lobes on the sampled signal. Spectra were acquired in absorbance mode using 56 scans at a resolution of 4 cm⁻¹ in the range of 4000-500 cm⁻¹. The fabrics, randomly sampled to ensure consistent analysis and reproducibility, were used as such.

### 2.7. Antibacterial Assays

### 2.7.1. Agar Diffusion Method

This assay was conducted with the limonene and vanillin microcapsules suspensions after applying the washing procedure described previously. Moreover, the free active agents were also tested separately (not incorporated in microcapsules). Staphylococcus aureus (ATCC 19213) and Escherichia coli (ATCC 10536) were used as representatives for Gram positive and Gram negative bacteria, respectively. The bacterial inoculums were prepared, under aseptic conditions, by transferring 4 isolated colonies of each type to individual test tubes containing nutrient broth and then incubated at 37° C. for 24 hours. The inoculums were then diluted by sterilized Ringer solution to a concentration of 0.5 McFarland turbidity (concentration of 1.5-3.0×10⁸ CFU/ml). The concentration of the bacteria dilutions, also ascertained through UV spectrophotometry at 625 nm, was 0.0938 for the S. aureus, and 0.0940 for the E. coli. The bacterial solutions were then inoculated on the surface of Mueller Hinton Agar plates, using sterilized cotton swabs, and thereafter allowed to dry. Then, a well of 6 mm diameter was made in the center of each inoculated plate; the plug was removed, and filled with 100 μl of the microcapsules suspension. The limonene oil was diluted in dimethyl sulfoxide (DMSO) (7:3 ratio), and the vanillin dissolved in corn oil (0.03 g vanillin in 1 g of oil). The plates were incubated at 37° C. for 24 h. After this time period, the diameter of the inhibition zone was measured and incubation maintained for more 4 days in order to evaluate further changes in the inhibition zone. The clear zone formed, after incubation, around each hole (inhibition halo), indicates antimicrobial activity and its diameter is a measure of the inhibitory effect. All of the tests were done in duplicates.

### 2.7.2. Standard Test Method Under Dynamic Contact Conditions

This test aimed at evaluating the antibacterial activity of the impregnated fabrics. It is based on the American Society for Testing and Materials standard (ASTM) Designation: E 2149-01 standard method, designed to analyze samples treated with non-leaching (substrate-bound) antimicrobial agents under dynamic contact conditions.⁴³ In this work the bacterial inoculum was adjusted to 0.5 McFarland turbidity standard (concentration of 1.5-3.0×10⁸ CFU/mL) using sterilized Ringer solution. The concentration of the bacteria dilutions was measured spectrophotometrically at 625 nm. This solution was then diluted in a sterile buffer of 0.3 mM KH₂PO₄ (pH=7.2±0.1) to reach a concentration of 1.5-3.0×10⁵ CFU/ml, and used as the working bacterial dilution employed in the assays. For the determination of bacterial inhibition, a fabric sample impregnated with the microcapsules (2×2 cm²) was introduced into 50 ml of the working bacterial dilution placed in a sterile 250 ml flask. The flask was capped and placed in an orbital stirring bath at 37° C. After one minute of stirring, 1 ml of the solution was aseptically collected to determine bacterial concentration by the standard plate counting technique; which involves using serial dilutions and incorporation in Petri dishes with nutrient agar. The obtained value was considered as the bacteria concentration at the initial contact time (t0). After taking the sample, the flask was immediately returned to the bath and stirred for a further 15 minutes. Then, a new sample of the solution was aseptically collected for bacteria counting. The results of colony counting were converted to colony forming units per milliliter (CFU/ml) and used to calculate the percentage of bacterial reduction. Two other flasks, one containing the untreated fabric sample (fabric without microcapsules), and another flask containing only the working bacterial dilution (without sample addition), both submitted to the same procedure of colony counting and percentage of bacteria reduction determination, were used as control. After the first 15 minutes of testing, the inoculum solution of the treated fabric samples and the blank control were renewed and the sampling was repeated for bacteria counting at 30, 45, 60, 75, 90, 105 and 120-minute time periods. Before renewing the inoculum solution of the fabric sample, the sample was always washed with sterile deionized water. The step of the inoculum renewing (every 15 minutes) is a modification of the original E 2149-01 standard and gives a better idea about the real amount of inhibition after that time of exposure.⁴⁴ The percent of bacterial reduction upon contact with the fabric samples was calculated using the following equation:⁴³

$$Reduction ( \% ) = \frac{( A - B )}{A} \times 100 \qquad ( 5 )$$

where B is the CFU/ml for the flask containing the treated fabric sample after the specified contact time and A is the CFU/ml for the flask containing the inoculum before the addition of the treated fabric.

### 3. Results and Discussion

### 3.1. Microcapsules Characterization

The hydrophilic-lipophilic balance (HLB) reflects the adequacy of the emulsifier to a certain application. Emulsifiers with low HLB values (4.7-6.7) are usually used to obtain w/o emulsions, whereas o/w emulsions are obtained by emulsifiers with higher HLB values (9.6-17.6).⁴ However, some articles in the literature reported microencapsulation processes by complex coacervation where low HLB value emulsifiers have been used (e.g., Span 83),⁴⁰ being this strategy followed in this work where PGPR (HLB of 2-4) and Span 85 (HLB of 1.8)⁴⁶ have been chosen. The Span family emulsifiers are currently used in these types of microencapsulated systems. Concerning the PGPR, a biodegradable emulsifier manufactured from the esterification of castor oil fatty acids with polyglycerol, is reported to have no potential threat to the environment.⁴⁷ In addition, toxicological studies demonstrated that it does not have any health hazards.⁴⁸

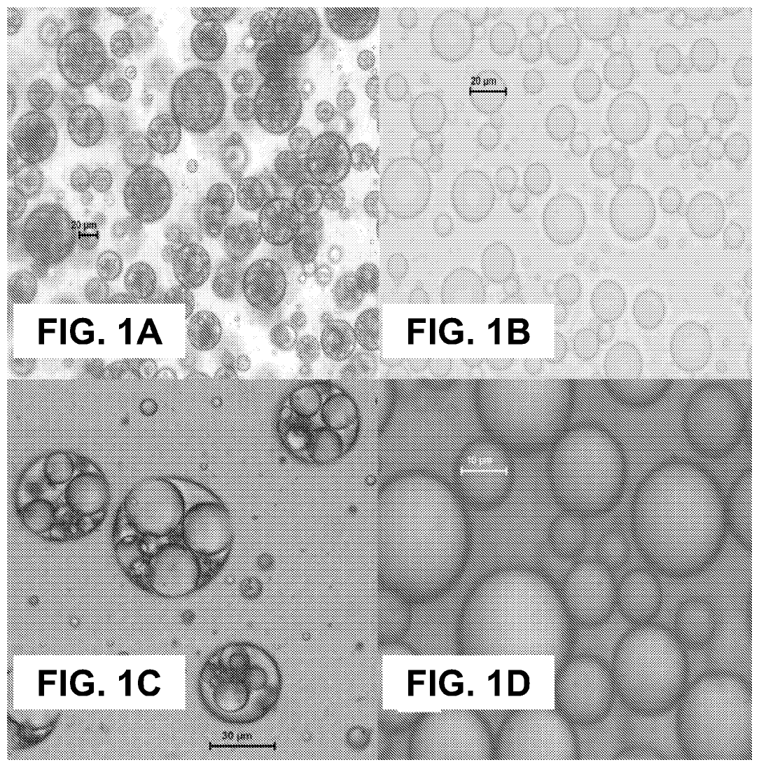

From optical microscopy analysis (FIGS. 1A-D), it was possible to observe two main types of morphology (mono- and polynuclear) depending on the type of emulsifier used. The ones prepared with PGPR presented a polynuclear morphology, whereas formulations prepared with Span 85 showed a mononuclear morphology; regardless of the type of the active agent.

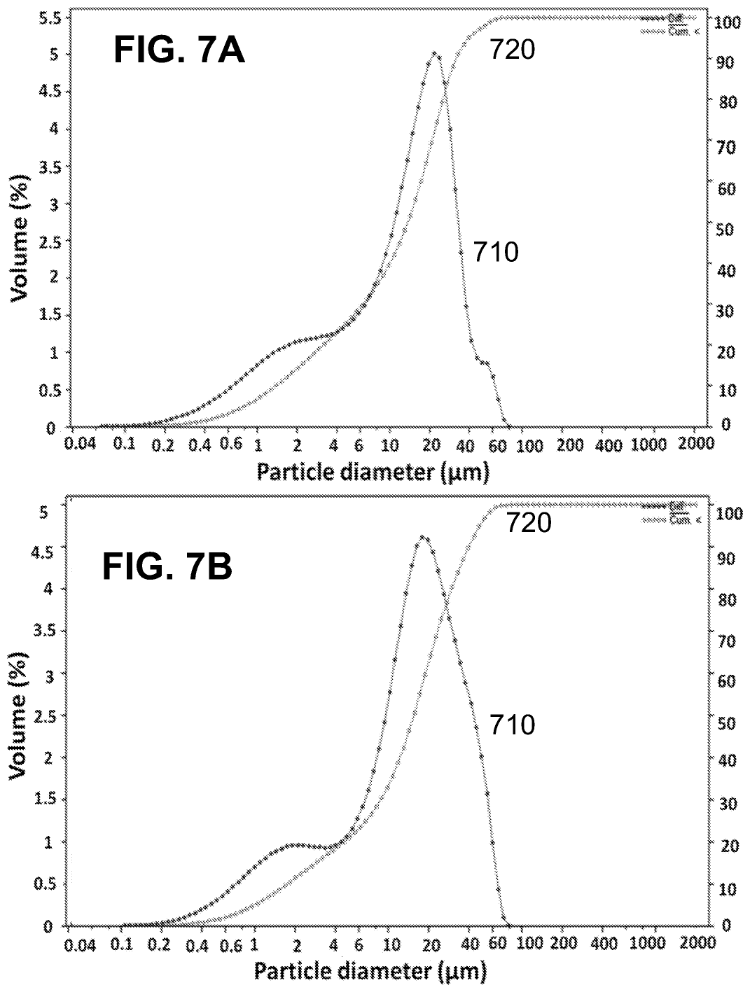

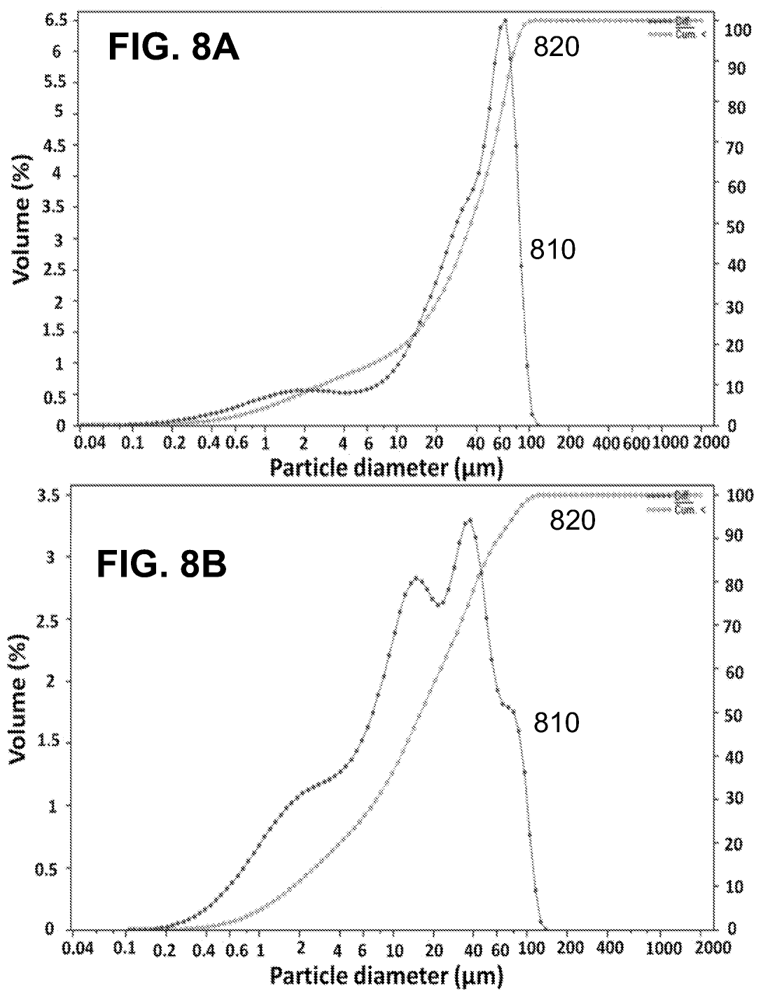

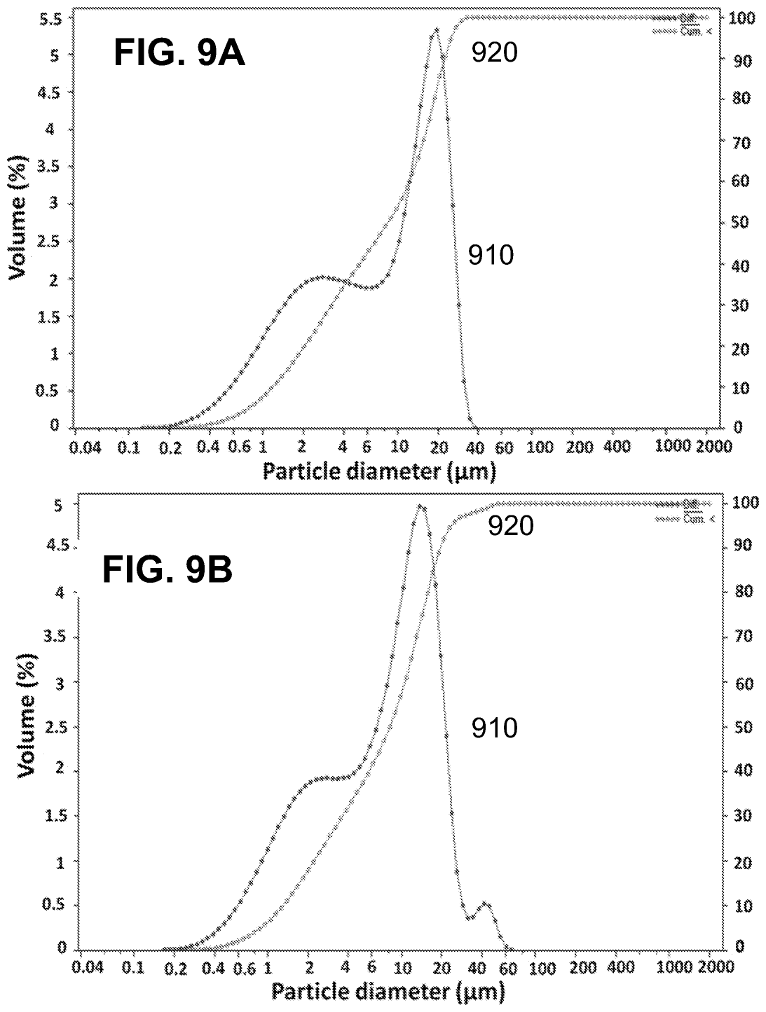

Table 2 shows the mean diameters of the produced microcapsules, as well as the values obtained for the solid content and microencapsulation efficiency. The graphs of the differential and cumulative particle size distribution in volume are shown in FIGS. 7A-B, FIGS. 8A-B and FIGS. 9A-B. For the same amount and type of core material; vanillin formulations 1 and 3, and limonene formulations 4 and 6, the use of PGPR emulsifier produced microcapsules with larger average size than the corresponding Span 85 counterparts. In fact, the mean particle size changes from 15.7 μm to 10.4 μm and from 18.4 μm to 11.1 μm, for vanillin and limonene formulations, respectively when PGPR was replaced by Span 85. The particle size distribution was also affected by the core material/wall ratio. In the present study, it was noticed that keeping the amount of wall materials constant and increasing the amount of core material (from 1 to 4.5 g), i.e. by increasing the core material/wall material ratio (from 0.67 to 3), resulted in a significant increase of the determined mean diameter of the microcapsules (vanillin formulations 1 and 2 and limonene formulations 4 and 5, which mean diameter increased from 15.7 μm to 38.3 μm and 18.4 μm to 39.0 μm, respectively). The increase in the size of the microcapsules with increasing the core material/wall material ratio has been reported in the literature involving preparations by complex coacervation.^{39,40,49} Dong et al.⁴⁶ explained this by stating that concerning the multinuclear microcapsules, the increase in the ratio core material/wall material results in an increased amount of emulsion droplets available in the suspension during the preparation, which subsequently forms larger spherical coacervate polynuclear microcapsules.

In what concerns the EE %, it ranged between 90.4% and 100% as shown in Table 2. The values are significantly higher than the ones reported by Pakzad et al.²⁷ who obtained an EE % falling in the range of 53% to 82% by using also tannic acid as a hardening agent for peppermint oil microencapsulation by complex coacervation using gum Arabic and gelatin, and Tween 80 as emulsifier. In this work, the best EE % values were achieved with Span 80 (100 and 98.6%, respectively for vanillin and limonene). These results are in agreement with those obtained by Rabiskovi et al who stated that the use of emulsifiers with low HLB values (1.8 and 6.7) in the preparation of o/w emulsions for complex coacervation results in higher values of EE %, indicating the preference of the encapsulation of hydrophobic materials for emulsifiers with low HLB value. The authors also reported the inability of emulsifiers with high HLB values, such as Tween 81 and Tween 80 (HLB=10 and 15, respectively) to encapsulate oils by complex coacervation using gelatin and gum Arabic as wall materials.

Comparing the two used active agents, it was observed that formulations obtained using vanillin generally resulted in higher EE %, comparatively with the corresponding formulations using limonene. This might be due to the fact that vanillin was dissolved in corn oil (as viscous carrier) that might have decreased its diffusivity through the wall material. In contrast, in the case of limonene, it was directly used without the need of a solubilizing medium, hence diffused more readily.

### 3.2. Microcapsules Release Studies

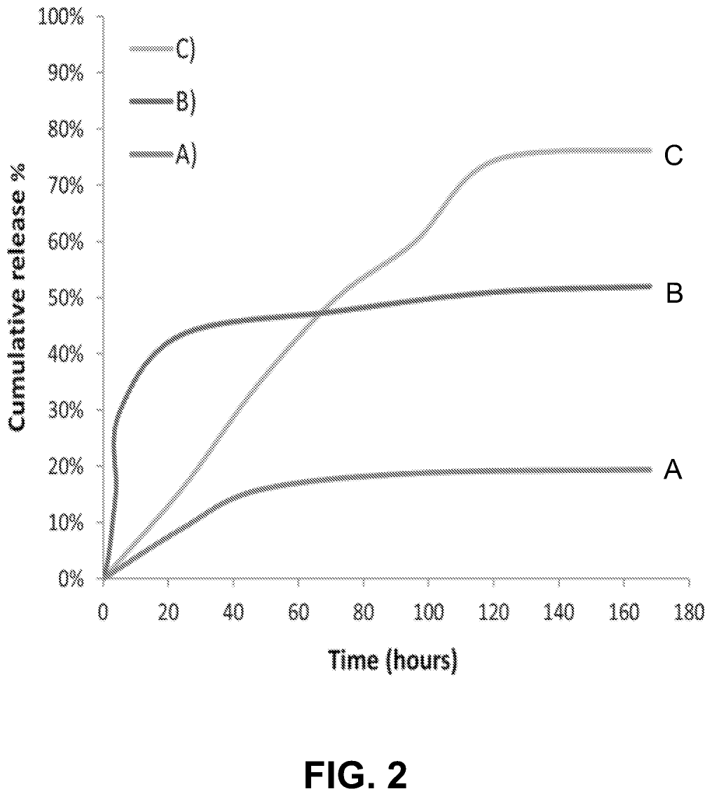

The cumulative release profiles of formulations 2, 4 and 6 are shown in FIG. 2. It could be observed that the release profiles of the three formulations exhibited a two-stage behavior; firstly a phase characterized by a burst release effect then followed by a slowly rising plateau pattern of gradual sustained release.⁵¹ The release profile of vanillin from the polynuclear microcapsules (Formulation 2), in which PGPR was used as the emulsifier was more prolonged than the limonene release from the microcapsules of formulation 4 (prepared with the same emulsifier (PGPR) thus having similar morphology). The faster release behavior of limonene in the first phase of the release pattern (before reaching the plateau) can be justified by the better affinity it presents with the release medium (hexane), comparatively with vanillin. In formulation 2, the plateau was attained after 48 hours; whereby approximately 16% of the total encapsulated vanillin was released, whereas in formulation 4 the stable sustained release phase started earlier (after approximately 24 hours); whereby 43% of the incorporated limonene was released. Furthermore, it was observed that after 7 days (168 hours), the vanillin total cumulative release reached 19.4%, unlike limonene formulation 4 in which 52% was released within the first 7 days under the same conditions (37° C. and 100 rpm). This slower release rate behavior is probably related to the chemical and structure differences between vanillin and limonene, and their ability to diffuse through the polymer wall, added to that the fact that vanillin, unlike limonene, was dissolved formerly in corn oil. The results obtained are in accordance with the vanillin slow and sustained release profile that was reported by Dalmolin et al.⁵² who used poly-lactic acid to encapsulate vanillin and obtained a biphasic slow pattern with 20% cumulative vanillin release after 120 hours.

By comparing the two release curves for limonene (formulation 4 and 6), it could be observed that a faster initial release was achieved with formulation 4. Also, the stable sustained release phase started earlier (after almost 24 hours) in formulation 4 (FIG. 2B); whereby 43% of the incorporated limonene was released. The same phase started in formulation 6 (FIG. 2C) after 120 hours (5 days) where about 74% of the encapsulated limonene was released. It is notable that after 7 days (168 hours), at 37° C. and 100 rpm, for both formulations, the overall cumulative release for the mononuclear microcapsules was about 75%, whereas a value of 52% was achieved with the polynuclear microcapsules. In this context, it could be concluded that the release rate is lower in the polynuclear microcapsules than in the case of mononuclear microcapsules. These results are in agreement with those described by Jégat et al.⁵³ who used different stirring speeds to produce mononuclear and polynuclear microcapsules, and reported a lower release rate for the polynuclear ones. It has been also reported by Dong et al that, comparatively with mononuclear microcapsules, the polynuclear ones give rise to better controlled release behavior, making them more favorable for applications requiring prolonged release.¹⁴

### 3.3. Textile Impregnation Studies

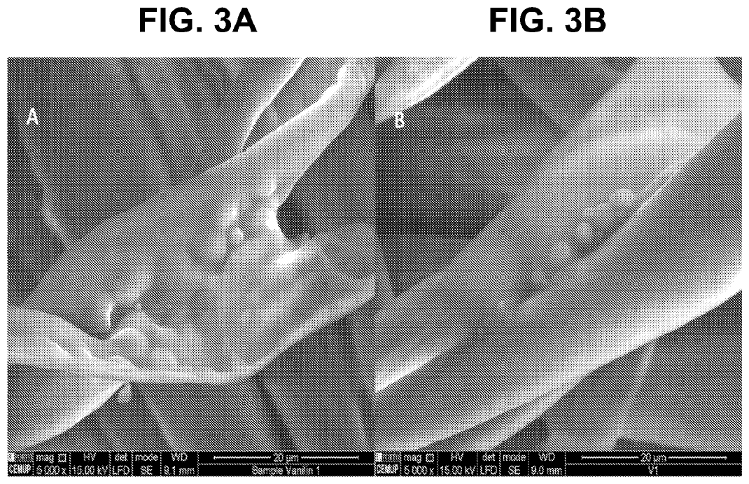

SEM was used to examine the cotton fabrics impregnated with microcapsules of different formulations and grafted thermally with citric acid. FIG. 3A shows the fabric treated with vanillin microcapsules obtained from formulation 1; dried at 90° C. for 2 minutes and cured at 120° C. for 3 minutes. It was observed that a thin film-like covers the microcapsules. This film was considerably less evident when the curing conditions were changed to 150° C. (2 minutes) as shown in FIG. 3B.

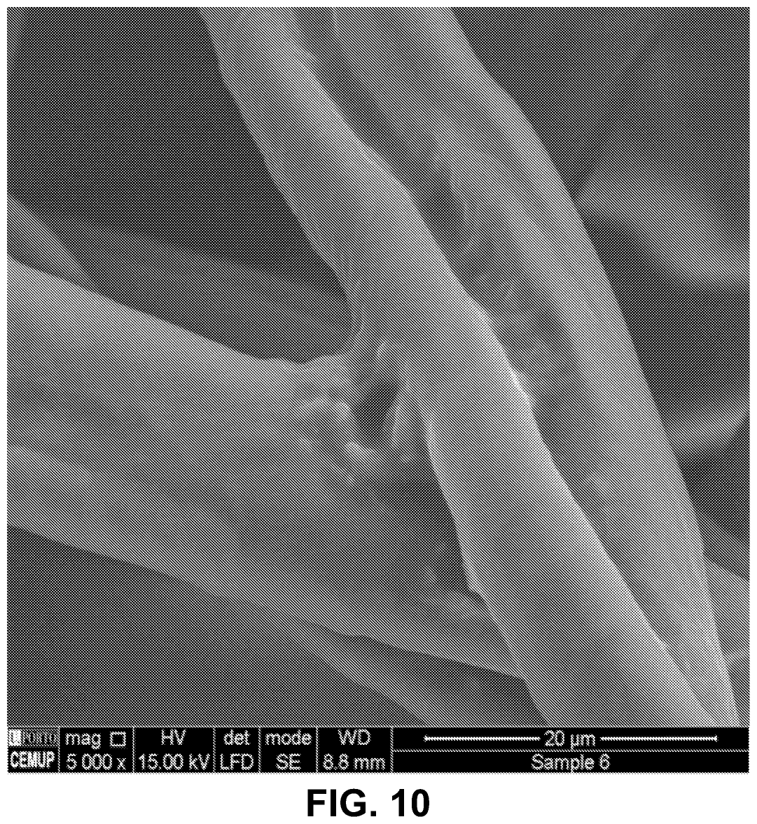

SEM image of fabrics treated with limonene microcapsules obtained from formulations 4 is shown in FIG. 10. Despite the fact that both formulations 1 and 4 were prepared with the same amounts of PGPR (0.35 g) and the hardening agent tannic acid (0.2 g), and undergone the same drying conditions (90° C. for 2 minutes) and curing (120° C. for 3 minutes), it could be observed that more vanillin microcapsules were effectively grafted on the fabric (FIG. 3A) than the limonene ones (FIG. 10). This suggests that formulation 1 is more thermally stable than formulation 4.

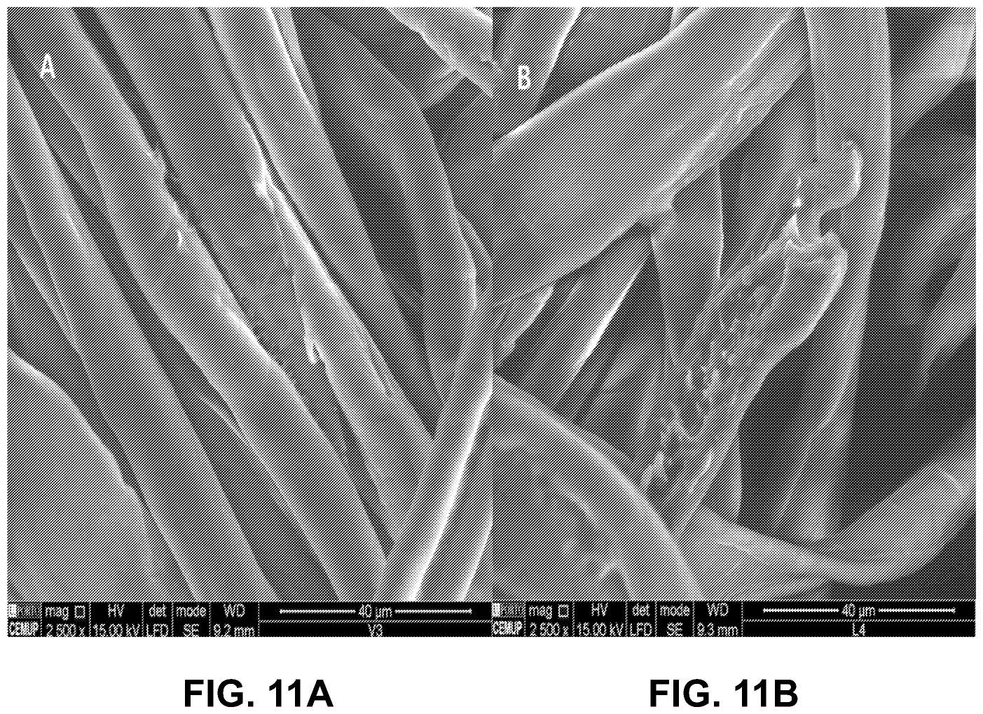

Fabrics impregnated with formulations 3 and 6; formulations produced with Span 85, did not show any attached microcapsules after the drying and curing steps (90° C. for 2 minutes and 120° C. for 3 minutes). However, some remnants of the microcapsules could be observed in the interstices between the fabric fibers as shown in FIGS. 11A-B. This suggests that microcapsules prepared with Span 85 have a low thermal stability and were destroyed during thermal curing.

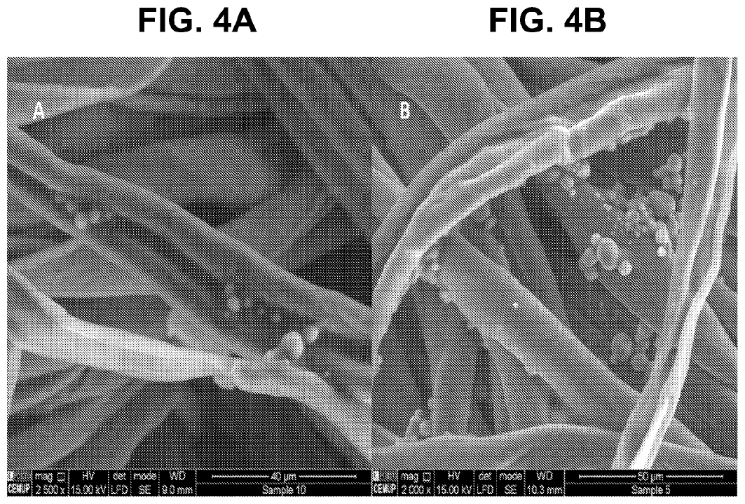

The most successful formulation were vanillin microcapsules according to formulation 2 and limonene microcapsules according to formulation 5 (FIGS. 4A and 4B, respectively), applying a temperature of 90° C. (2 minutes) for thermofixation and curing temperature of 120° C. for 3 minutes. These formulations presented higher solid content (29.7% and 28.8%, respectively for formulation 2 and 5), fact that was associated with the used high amounts of PGPR, and the presence of tannic acid as hardening agent, which resulted in microcapsule's improved thermal stability. It was also noticed that the increase of emulsifier, together with the increase of core material (limonene oil or vanillin dissolved in corn oil) made the limonene formulation endure the treatment better than the vanillin one; on the contrary to what was previously observed with formulations 1 and 4 (formulations with lower amounts of emulsifier and core materials), where the vanillin formulation gave rise to better results than the limonene one. The impact was obviously perceptible in the amount of fixed microcapsules and their distribution. Although the curing was performed at the same temperature, the film that covered the microcapsules in the previous formulations did not appear in this last case (of formulation 2 and 5), revealing the smooth appearance of the microcapsules surface. In contrast to the relatively wide size distribution of particle size of the grafted formulations (FIGS. 7A-B and FIGS. 8A-B), it was observed that the microcapsules grafted and retained on the textiles after curing were predominantly the ones of small size. This can be possibly attributed to the removal of the high size microcapsules during the washing step that was applied before the thermofixation and right after the reaction with citric acid. Monllor et al. reported a similar observation and concluded that the smaller microcapsules tend to remain on the fabrics after several washing cycles, whereas the larger ones are usually lost faster.⁵⁴

The concentration of citric acid has been reported in the literature to affect the degree of whiteness of the treated fabric, as well as the degree of the cross-linking reaction.³³ In the present work, and in order to guarantee the desired characteristics of the fabric, low concentrations of citric acid were used, even lower than the ones mentioned in the cited literature;^{32,33} as we took into consideration the low availability of functional groups (amino groups) on microcapsules surface due to its consumption during the complex coacervation process. No whiteness loss was observed by qualitative inspection. Moreover, the used concentration gave rise to well grafted microcapsules (FIGS. 4A-B). Qualitative inspection has also shown that the fabrics remained pliable and flexible after the treatment. This is actually one of the advantages of applying chemical grafting over using polymeric binders to fix the microcapsules onto the fabrics. The chemical grafting has been reported to maintain the breathability and flexibility of the fabrics, in opposition to polymeric binders that are reported to change the tensile strength and elasticity, and decrease the flexibility, air permeability and softness of the fabric.^{55,56}

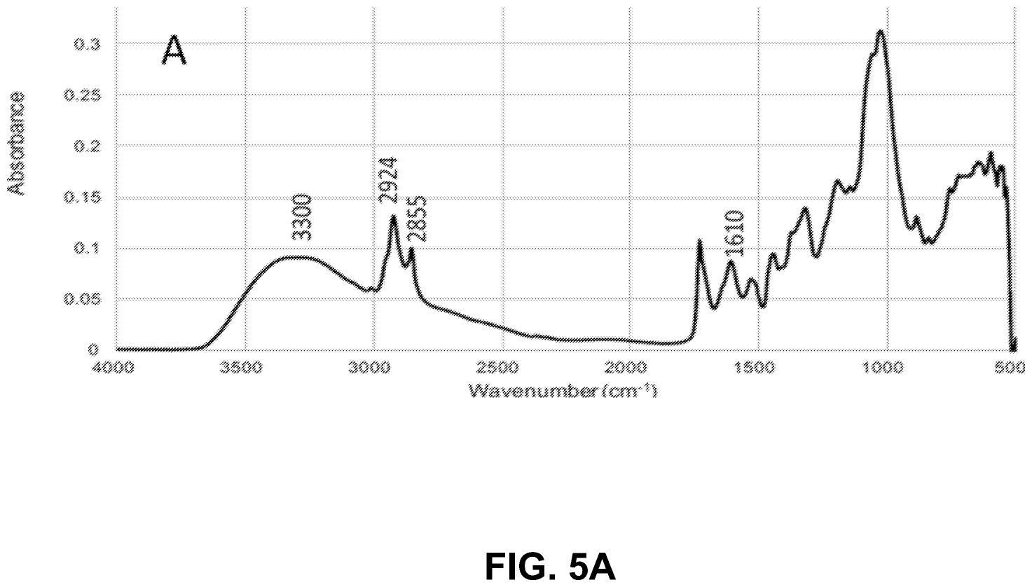

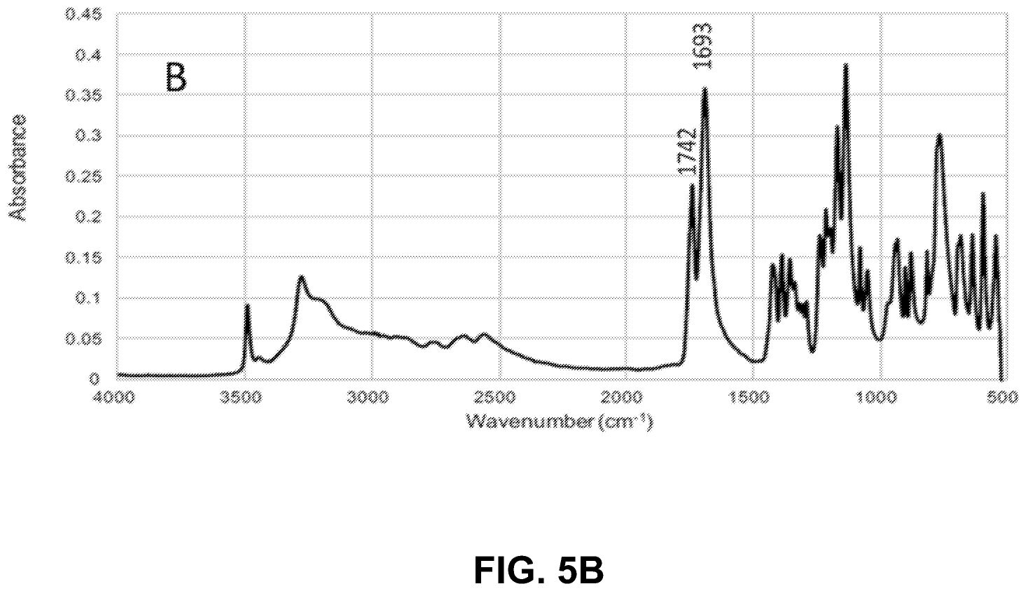

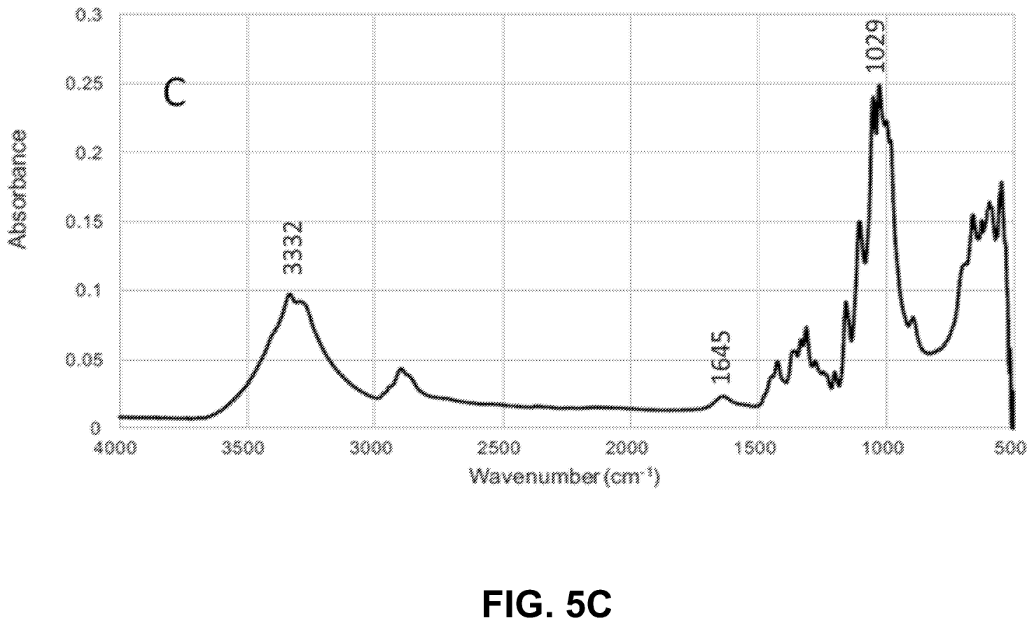

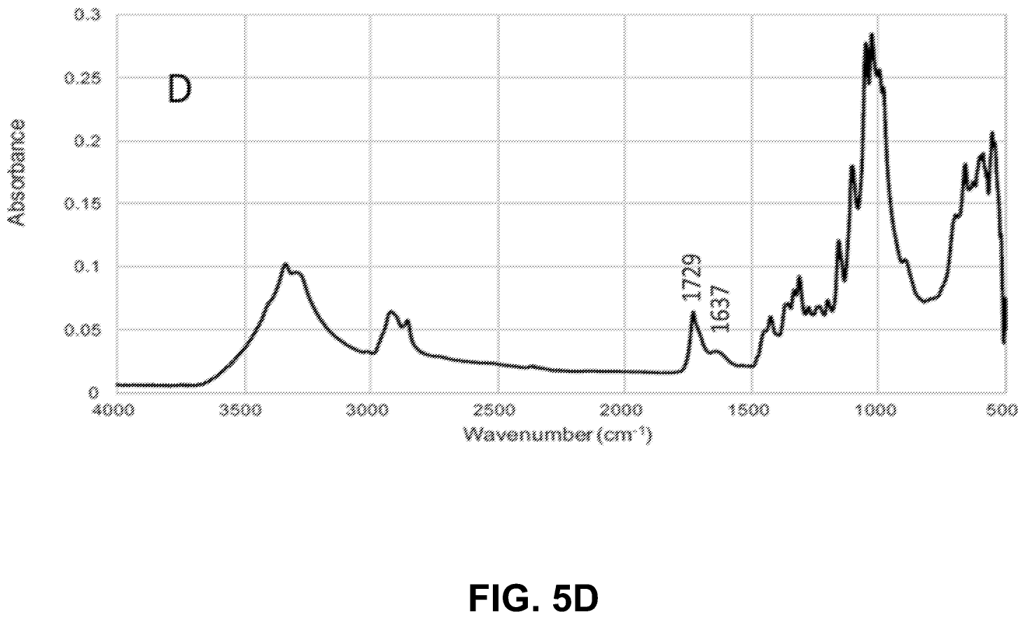

The effectiveness of the impregnation studies, namely the occurrence of the grafting reaction between the cotton fabric and the microcapsules via the citric acid, was examined by FTIR. FIGS. 5A-D show the spectra of the limonene microcapsules (freeze-dried samples from formulation 5), citric acid (cross-linker), untreated cotton fabric (control), and the treated cotton fabric (with formulation 5, cured at 120° C. for 3 minutes). Table S1 lists the significant peaks of the spectra and their functional groups.^{32,38,55,57} The spectrum of the chitosan/gum Arabic microcapsules loaded with limonene (FIG. 5A) showed the presence of an important peak at 2855 cm⁻¹. This peak was reported in the literature in the spectra of microcapsules prepared by complex coacervation between chitosan and gum Arabic.^{38,40} Additionally, the broad band centered at 3300 cm⁻¹ is attributed to the —OH groups of both chitosan and gum Arabic overlapped with the —NH stretching of chitosan. This band can also represent the hydrogen bonds established between gum Arabic and chitosan.³⁸ The spectrum of cotton fabric impregnated with limonene microcapsules (FIG. 5D) has shown the disappearance of the sharp peaks at 1742 cm⁻¹ and 1693 cm⁻¹ that previously appeared in the spectrum of the cross-linker citric acid (FIG. 5B), which indicates that they had become involved in bonding, i.e., the esterification reaction between the carboxylic group of citric acid and the —OH group of the cotton cellulose.³² The spectrum of the grafted cotton fabric also revealed the appearance of a new peak of C═O ester stretching at 1729 cm⁻¹, which was not present in the control cotton fabric sample (FIG. 5C). This peak confirms the covalent attachment between the polymeric shell of the microcapsules (of chitosan and gum Arabic) and cotton cellulose via citric acid through ester bond formation.⁵⁸ Additionally, the presence of a peak at 1637 cm⁻¹ with small intensity, which is assigned to the bending vibration of the —NH group, points out to the chemical reaction between the residual free —NH₂ groups of chitosan in the microcapsules shells and the —COOH groups of citric acid.³²

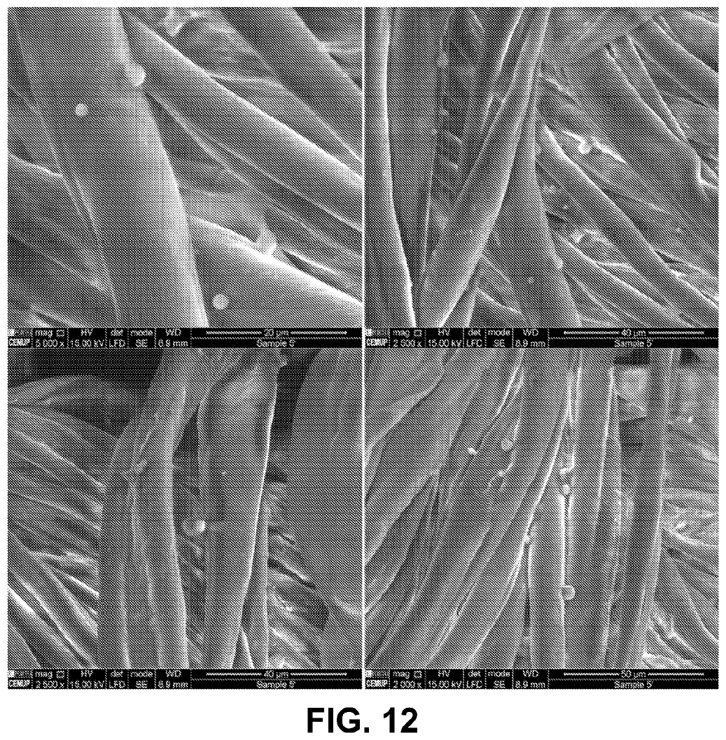

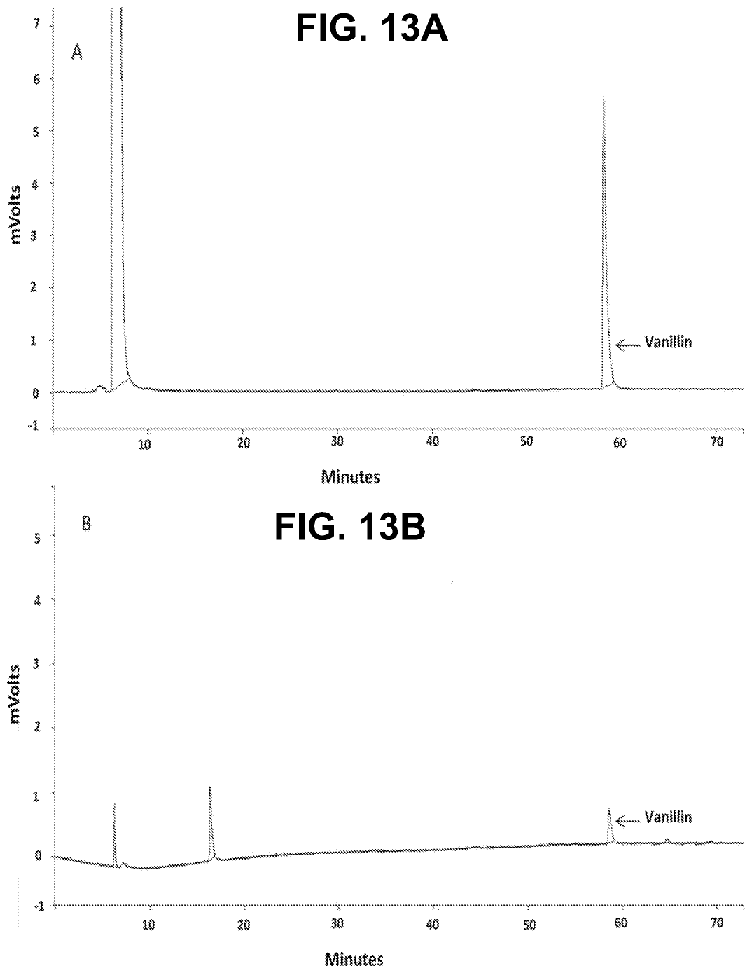

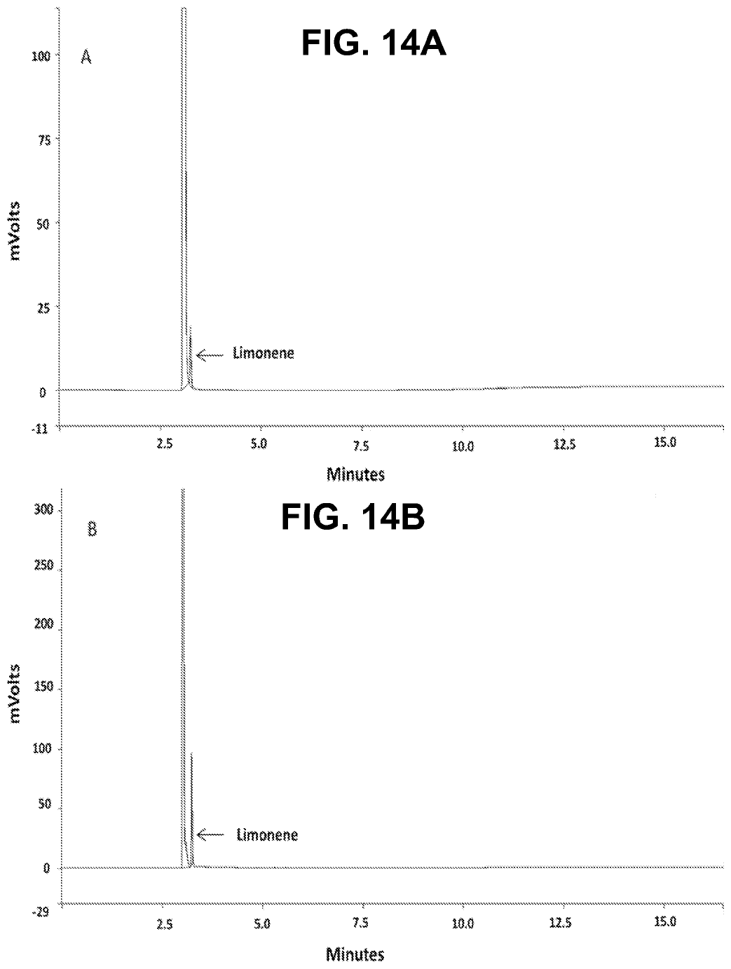

These FTIR results are complemented by SEM images (FIG. 12) of cotton fabrics impregnated with limonene microcapsules (formulation 5) after being washed with 2% commercial soap and 0.1N acetic acid where the grafted microcapsules are clearly seen. This not only suggests successful grafting but also that the grafted microcapsules were not detached during the washing.

### 3.4. Evaluation of Antibacterial Activity

### 3.4.1. Agar Diffusion

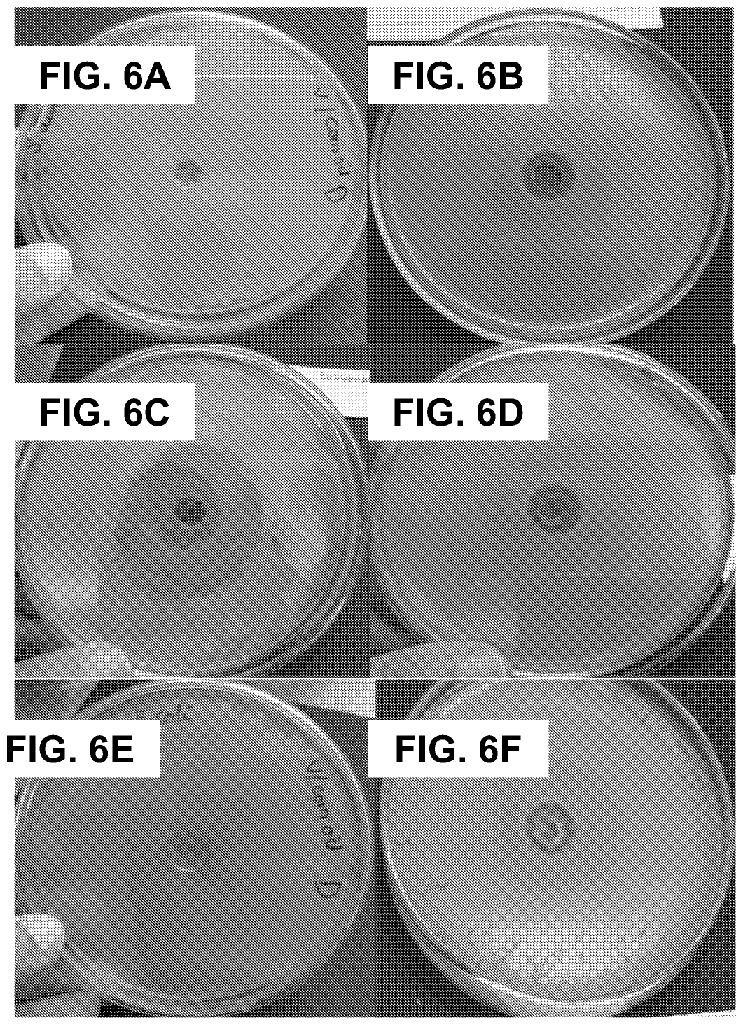

This assay was conducted to investigate the antibacterial activity of the free microcapsules before being grafted onto the fabrics. FIGS. 6A-F compares the results of the agar diffusion assay of the encapsulated core materials with the non-encapsulated ones. Table 3 lists the values of the measured diameters of the inhibition zones of the formulations after incubating the plates for 24 hours and for 4 days; the results indicated that all the microcapsules formulations exhibited bacterial growth inhibition against both S. aureus and E. coli. It has been observed for the inhibition zones initially obtained for the non-encapsulated active agents (limonene or vanillin), that after 4 days of incubation, they have become covered with bacteria. In contrast, the bacterial effect of the encapsulated oil was maintained after 4 days of incubation under the same conditions. This sustainable antibacterial effect of the encapsulated limonene and vanillin in the examined microcapsules formulations is acquired as a result of the achieved controlled release, and demonstrates the enhanced stability and prolonged antibacterial effect of the encapsulated core materials. The higher initial antibacterial effect that was exhibited by the non-encapsulated limonene oil dissolved in DMSO, and manifested in the bigger zone of inhibition (as shown in FIG. 6C and values in Table 3) might be related to the antibacterial activity of DMSO along with the limonene.⁵⁹ Since the antibacterial effect of chitosan mainly depends on the presence of its positively charged amino groups freely to interact with the negative charges of the bacterial wall,⁶⁰ it is important to mention that the antibacterial effect exhibited by the microcapsules is predominantly due to the encapsulated vanillin and limonene during their release trough the microcapsules wall (chitosan and gum Arabic), and not from the chitosan itself. This is because during the microcapsules preparation process by the complex coacervation method most of the positively amino groups of chitosan have been complexed with negative carboxylic groups of the gum Arabic to form the shell of the microcapsules.

### 3.4.2. Standard Test Method Under Dynamic Contact Conditions

This bacterial reduction assay was conducted on cotton fabrics impregnated with vanillin microcapsules of formulation 2 and limonene microcapsules of formulation 5 (cured at 120° C. for 3 minutes); as they gave good grafting outcome. The results of the assay are shown in Table 4 (more details are shown in Tables S2 and S3). It can be observed, that both fabric samples exhibited an antibacterial activity against E. coli, whereby the fabric treated with limonene microcapsules showed 95.90% of bacterial reduction and the one impregnated with vanillin microcapsules showed 98.17% after 15 minutes of contact. A bacteriostatic activity is generally regarded if a reduction percentage between 90% and 99.9% of the total bacteria count (CFU/mL) in the original inoculum is obtained.^{44,61} As was mentioned previously, this assay involved the renewal of the bacterial inoculum at each sampling. In other words, every 15 minutes the fabric sample was withdrawn, washed thoroughly with sterilized water and placed in contact with a new/fresh bacterial inoculum in order to take samples for colony counting. It is obvious from the obtained results that although the bacterial reduction percentage decreased with time, it was showed throughout the 8 renewal cycles for both fabric samples. This antimicrobial effect is also evidence of the successful grafting of the prepared microcapsules to the fabric which as the results show have endured 8 renewal cycles in contact with a highly-concentrated inoculum solution.

### 4. Conclusions

The production of limonene and vanillin microcapsules was accomplished by means of the complex coacervation using gum Arabic and chitosan as shell materials and tannic acid as a green hardening agent. The type of the emulsifier used in the microcapsule preparation was found to have a significant influence on their size, morphology (being mononuclear or polynuclear), EE % and the release pattern of the core material through the wall. The release profile was affected by the type of core material and the morphology of the microcapsules. Among the different formulations that were prepared, it was confirmed that the multinuclear limonene and vanillin microcapsules obtained by 0.6 g PGPR and 4.5 g of the core material are the ones that tolerated the thermofixation and curing conditions. This highlights the fact that some formulations, regardless of their high EE % and uniform release profiles were not suitable for the grafting reaction and could not survive its high temperature. The antibacterial assays of both the free microcapsules and the treated cotton fabrics have shown that they exhibited a sustained antibacterial activity.

TABLE 1
The chemical system of the formulations.

| Formulation | Activeprinciple | Carrier oil | Emulsifier |
|---|---|---|---|
| 1 | Vanillin (0.02 g) | Corn oil (1 g) | PGPR (0.35 g) |
| 2 | Vanillin (0.12 g) | Corn oil (4.5 g) | PGPR (0.6 g) |
| 3 | Vanillin (0.02 g) | Corn oil (1 g) | Span 85 (0.35 g) |
| 4 | Limonene (1 g) | — | PGPR (0.35 g) |
| 5 | Limonene (4.5 g) | — | PGPR (0.6 g) |
| 6 | Limonene (1 g) | — | Span 85 (0.35 g) |

— No carrier oil was used.

TABLE 2
The mean diameter, solid content and encapsulation
efficiencies of the produced microcapsules.

| | Mean diameter in volume | Solid content | EE |
|---|---|---|---|
| Formulation | (μm) | (% w/w) | (% w/w) |
| 1 | 15.7 | 28.3% | 95.7% |
| 2 | 38.3 | 29.7% | 98.3% |
| 3 | 10.4 | 25.4% | 100% |
| 4 | 18.4 | 27.8% | 90.4% |
| 5 | 39.0 | 28.8% | 94.1% |
| 6 | 11.1 | 25.3% | 98.6% |

TABLE 3
Average diameters of inhibition zones (cm) of limonene and vanillin microcapsules
suspensions and free oils in the plate test with E. coli and S. aureus.

| | | | E. coli | | S. aureus | |
|---|---|---|---|---|---|---|
| | | | After 24 hours | After 4 days | After 24 hours | After 4 days |
| Formulation | | | of incubation | of incubation | of incubation | of incubation |
| Core | Vanillin | 1 | 1.45 ± 0.21 | 1.45 ± 0.21 | 1.45 ± 0.07 | 1.45 ± 0.07 |
| material | | 2 | 1.50 ± 0.00 | 1.55 ± 0.07 | 1.50 ± 0.00 | 1.55 ± 0.07 |
| | | 3 | 0.80 ± 0.00 | 1.20 ± 0.00 | 1.55 ± 0.07 | 1.55 ± 0.07 |
| | Limonene | 4 | 1.25 ± 0.08 | 1.25 ± 0.08 | 1.50 ± 0.13 | 1.50 ± 0.13 |
| | | 5 | 1.50 ± 0.00 | 1.50 ± 0.00 | 1.45 ± 0.07 | 1.45 ± 0.07 |
| | | 6 | 1.25 ± 0.40 | 1.25 ± 0.40 | 1.35 ± 0.07 | 1.35 ± 0.07 |

| | | | | |
|---|---|---|---|---|
| Vanillin in corn oil | 0.95 ± 0.32 | — (*) | 1.00 ± 0.20 | — (*) |
| Limonene in DMSO | 3.30 ± 0.31 | — (*) | 3.30 ± 0.18 | — (*) |

— (*) After 4 days of incubation, the bacteria grown up in the inhibition zone initially formed.

TABLE 4
Results of the bacterial reduction % in the dynamic test
of the fabrics impregnated with vanillin and limonene
microcapsules of formulations 2 and 5, respectively.

| | |
|---|---|
| Time | Bacterial reduction (%) |

| (minutes) | Vanillin | Limonene |
|---|---|---|
| 0 | 55.30 | 49.00 |
| 15 | 98.17 | 95.90 |
| 30 | 43.60 | 52.72 |
| 45 | 35.51 | 43.70 |
| 60 | 34.80 | 36.33 |
| 75 | 30.63 | 35.92 |
| 90 | 29.80 | 33.44 |
| 105 | 29.50 | 33.03 |
| 120 | 23.46 | 26.72 |

TABLE S1
Peak locations and functional groups of FTIR spectra.
FIG. 5A (microcapsules)

| Peak | | |
|---|---|---|
| location | | Functional group ³⁸ |
| 3300 | cm⁻¹ | —OH groups of both chitosan and gum Arabic overlapped |
| | | with the —NH stretching of chitosan |
| 2924 | cm⁻¹ | C—H stretching vibration |
| 1610 | cm⁻¹ | —NH angular deformation in chitosan structure |

FIG. 5B (citric acid)

| Peak | | |
|---|---|---|
| location | | Functional group ³² |
| 1742 | cm⁻¹ | stretching C═O of the —COOH group of acids |
| 1693 | cm⁻¹ | |

FIG. 5C (untreated cotton fabrics) ^{55, 57}

| Peak | | |
|---|---|---|
| location | | Functional group |
| 3332 | cm⁻¹ | —OH stretching vibration |
| 1645 | cm⁻¹ | Due to the presence of interstitial water in the cellulosic |
| | | structure |
| 1029 | cm⁻¹ | —C—O—C— stretching vibration |

FIG. 5D (cotton fabrics impregnated with microcapsules)

| Peak | | |
|---|---|---|
| location | | Functional group |
| 1729 | cm⁻¹ | C═O of the formed ester bond |

TABLE S2
Results of the bacterial reduction % in the dynamic test of the
fabric impregnated with vanillin microcapsules of formulation 2.

| | Sample | | | |
|---|---|---|---|---|
| | | | Cotton fabric | |
| | | Control fabric | treated with | |
| | Inoculum | (without | vanillin | Bacterial |
| Time | solution (A) | microcapsules) | microcapsules | reduction * |
| (minutes) | (CFU/ml) | (CFU/ml) | (CFU/ml) (B) | (%) |
| 0 | 3.00 × 10⁵ | 2.94 × 10⁵ | 1.34 × 10⁴ | 55.30 |
| 15 | 3.00 × 10⁵ | 2.74 × 10⁵ | 5.50 × 10² | 98.17 |
| 30 | 2.50 × 10⁵ | 2.69 × 10⁵ | 1.41 × 10⁴ | 43.60 |
| 45 | 2.45 × 10⁵ | 2.93 × 10⁵ | 1.58 × 10⁴ | 35.51 |
| 60 | 2.36 × 10⁵ | 2.95 × 10⁵ | 1.54 × 10⁴ | 34.80 |
| 75 | 2.71 × 10⁵ | 2.94 × 10⁵ | 1.88 × 10⁴ | 30.63 |
| 90 | 2.82 × 10⁵ | 2.92 × 10⁵ | 1.98 × 10⁴ | 29.80 |
| 105 | 2.78 × 10⁵ | 2.94 × 10⁵ | 1.96 × 10⁴ | 29.50 |
| 120 | 2.60 × 10⁵ | 2.96 × 10⁵ | 1.99 × 10⁴ | 23.46 |

* Bacterial reduction % = (A − B)/A*100

TABLE S3
Results of the bacterial reduction % in the dynamic test of the
fabric impregnated with limonene microcapsules of formulation 5.

| | Sample | | | |
|---|---|---|---|---|
| | | | Cotton fabric | |
| | Inoculum | Control (fabric | treated with | |
| | solution | without | limonene | Bacterial |
| Time | (CFU/ml) | microcapsules) | microcapsules | reduction * |
| (minutes) | (A) | (CFU/ml) | (CFU/ml) (B) | (%) |
| 0 | 3.00 × 10⁵ | 3.00 × 10⁵ | 1.50 × 10⁴ | 49.00 |
| 15 | 3.00 × 10⁵ | 2.50 × 10⁵ | 1.24 × 10⁴ | 95.90 |
| 30 | 3.00 × 10⁵ | 2.96 × 10⁵ | 1.42 × 10⁴ | 52.72 |
| 45 | 3.00 × 10⁵ | 2.81 × 10⁵ | 1.69 × 10⁴ | 43.70 |
| 60 | 3.00 × 10⁵ | 2.94 × 10⁵ | 1.91 × 10⁴ | 36.33 |
| 75 | 2.98 × 10⁵ | 2.96 × 10⁵ | 1.91 × 10⁴ | 35.92 |
| 90 | 2.90 × 10⁵ | 2.86 × 10⁵ | 1.93 × 10⁴ | 33.44 |
| 105 | 3.00 × 10⁵ | 2.88 × 10⁵ | 2.20 × 10⁴ | 33.03 |
| 120 | 3.00 × 10⁵ | 3.00 × 10⁵ | 2.20 × 10⁴ | 26.72 |

* Bacterial reduction % = (A − B)/A*100

### REFERENCES

(1) Holme, I. Innovative Technologies for High Performance Textiles. Color. Technol. 2007, 123, 59.
(2) Nelson, G. Application of Microencapsulation in Textiles. Int. J. Pharm. 2002, 242, 55.
(3) Panisello, C.; Pefa, B.; Gilabert Oriol, G.; Constanti, M.; Gumi, T.; Garcia-Valls, R. Polysulfone/Vanillin Microcapsules for Antibacterial and Aromatic Finishing of Fabrics. Ind Eng. Chem. Res. 2013, 52, 9995.
(4) Rodrigues, S. N.; Martins, I. M.; Fernandes, I. P.; Gomes, P. B.; Mata, V. G.; Barreiro, M. F.; Rodrigues, A. E. Scentfashion®: Microencapsulated Perfumes for Textile Application. Chem. Eng. J. 2009, 149, 463.
(5) Specos, M. M. M.; Garcia, J. J.; Tornesello, J.; Marino, P.; Vecchia, M. D.; Tesoriero, M. V. D.; Hermida, L. G. Microencapsulated Citronella Oil for Mosquito Repellent Finishing of Cotton Textiles. Trans. R Soc. Trop. Med. Hyg. 2010, 104, 653.
(6) Ma, Z.; Yu, D.; Branford-White, C.; Nie, H.; Fan, Z.; Zhu, L. Microencapsulation of Tamoxifen: Application to Cotton Fabric. Colloids Surf, B 2009, 69, 85.
(7) Flambard, X.; Bourbigot, S.; Kozlowski, R.; Muzyczek, M.; Mieleniak, B.; Ferreira, M.; Vermeulen, B.; Poutch, F. Progress in Safety, Flame Retardant Textiles and Flexible Fire Barriers for Seats in Transportation. Polym. Degrad. Stab. 2005, 88, 98.
(8) Son, K.; Yoo, D. I.; Shin, Y. Fixation of Vitamin E Microcapsules on Dyed Cotton Fabrics. Chem. Eng. J. 2014, 239, 284.
(9) Sinchez-silva, L.; Rodriguez, J. F.; Romero, A.; Sánchez, P. Preparation of Coated Thermo-Regulating Textiles Using Rubitherm-RT31 Microcapsules. J. Appl. Polym. Sci. 2012, 124, 4809.
(10) Borreguero, A. M.; Talavera, B.; Rodriguez, J. F.; Valverde, J. L.; Gonzalez, J. L.; Carmona, M. Enhancing the Thermal Comfort of Fabrics for the Footwear Industry. Text. Res. J. 2013, 83, 1754.
(11) Smith, W. C. (Ed.) Smart textile coatings and laminates; Woodhead Publishing Ltd: Cambridge, 2010.
(12) Moreira, A. C. G.; Martins, I. M.; Fernandes, I.; Barreiro, M. F.; Rodrigues, A. E. Microencapsulation of Red and White Thyme Oil in Poly(Lactic-Co-Glycolic) Acid: Assessment of Encapsulation Efficiency and Antimicrobial Capacity of the Produced Microcapsules. Can. J. Chem. Eng. 2016, 94, 469.
(13) Nazzaro, F.; Orlando, P.; Fratianni, F.; Coppola, R. Microencapsulation in Food Science and Biotechnology. Curr. Opin. Biotechnol. 2012, 23, 182.
(14) Dong, Z. J.; Tour, A.; Jia, C. S.; Zhang, X. M.; Xu, S. Y. Effect of Processing Parameters on the Formation of Spherical Multinuclear Microcapsules Encapsulating Peppermint Oil by Coacervation. J. Microencapsul. 2007, 24, 634.
(15) Martins, I. M. Microencapsulation of Thyme Oil by Coacervation: Production, Characterization and Release Evaluation. Ph.D. Dissertation, University of Porto, Portugal, 2012.
(16) Junfeng Su, L.; Wang, L.; Ren, L. Fabrication and Thermal Properties of MicroPCMs: Used Melamine-Formaldehyde Resin as Shell Material. J. Appl. Polym. Sci. 2006, 101, 1522.
(17) Salaun, F.; Lewandowski, M.; Vroman, I.; Bedek, G.; Bourbigot, S. Development and Characterisation of Flame-Retardant Fibres from Isotactic Polypropylene Melt-Compounded with Melamine-Formaldehyde Microcapsules. Polym. Degrad. Stab. 2011, 96, 131.
(18) Cogliano, V. J.; Grosse, Y.; Baan, R. A.; Straif, K.; Secretan, M. B.; El Ghissassi, F. Meeting Report: Summary of IARC Monographs on Formaldehyde, 2-Butoxyethanol, and 1-tert-Butoxy-2-Propanol. Environ. Health Perspect. 2005, 113, 1205.
(19) Hebeish, A.; Abdel-Mohdy, F.; Fouda, M. M. G.; Elsaid, Z.; Essam, S.; Tammam, G. H.; Drees, E. A. Green Synthesis of Easy Care and Antimicrobial Cotton Fabrics. Carbohydr. Polym. 2011, 86, 1684.
(20) Shahid-ul-islam, M.; Shahid, F.; Mohammad, F. Green Chemistry Approaches to Develop Antimicrobial Textiles Based on Sustainable Biopolymers—A Review. Ind. Eng. Chem. Res. 2013, 52, 5245.
(21) Oliveira, B. F; Santana, M. H. A.; R, M. I. Spray-Dried Chitosan Microspheres Cross-Linked with d, 1-Glyceraldehyde as a Potential Drug Delivery System: Preparation and Characterization. Brazil. J. Chem. Eng. 2005, 22, 353.
(22) Xiao, Z.; Li, W.; Zhu, G. Effect of Wall Materials and Core Oil on the Formation and Properties of Styralyl Acetate Microcapsules Prepared by Complex Coacervation. Colloid Polym. Sci. 2015, 293, 1339.
(23) Xiao, Z.; Liu, W.; Zhu, G.; Zhou, R.; Niu, Y. A Review of the Preparation and Application of Flavour and Essential Oils Microcapsules Based on Complex Coacervation Technology. J. Sci. FoodAgric. 2014, 94, 1482.
(24) Dong, Z.; Xia, S.; Hua, S.; Hayat, K.; Zhang, X.; Xu, S. Optimization of Cross-Linking Parameters during Production of Transglutaminase-Hardened Spherical Multinuclear Microcapsules by Complex Coacervation. Colloids Surf, B 2008, 63, 41.
(25) Gouin, S. Microencapsulation: Industrial Appraisal of Existing Technologies and Trends. Trends Food Sci. Technol. 2004, 15, 330.
(26) Xing, F.; Cheng, G.; Yang, B.; Ma, L. Microencapsulation of Capsaicin by the Complex Coacervation of Gelatin, Acacia and Tannins. J. Appl. Polym. Sci. 2004, 91, 2669.
(27) Pakzad, H.; Alemzadeh, I.; Kazemi, A. Encapsulation of Peppermint Oil with Arabic Gum-Gelatin by Complex Coacervation Method. IJE 2013, 26, 807.
(28) Zhang, L.; Cheng, L.; Jiang, L.; Wang, Y.; Yang, G.; He, G. Effects of Tannic Acid on Gluten Protein Structure, Dough Properties and Bread Quality of Chinese Wheat. J. Sci. Food Agric. 2010, 90, 2462.
(29) Aracil, M. A; Bou-Belda, E.; Monllor, P.; Gisbert, J. Binder Effectiveness of Microcapsules Applied onto Cotton Fabrics during Laundry. J. Text. Inst. 2015, 107, 300.
(30) Murugesh Babu, K.; Ravindra, K. B. Bioactive Antimicrobial Agents for Finishing of Textiles for Health Care Products. J. Text. Inst. 2015, 106, 706.
(31) Specos, M. M. M.; Escobar, G.; Marino, P.; Puggia, C.; Tesoriero, M. V.; Hermida, L. Aroma Finishing of Cotton Fabrics by Means of Microencapsulation Techniques. J. Ind Text. 2010, 40, 13.
(32) Yang, Z.; Zeng, Z.; Xiao, Z.; Ji, H. Preparation and Controllable Release of Chitosan/Vanillin Microcapsules and their Application to Cotton Fabric. Flavour Frag. J. 2014, 29, 114.
(33) Fan, F.; Zhang, W.; Wang, C. Covalent Bonding and Photochromic Properties of Double-Shell Polyurethane-Chitosan Microcapsules Crosslinked onto Cotton Fabric. Cellulose 2015, 22, 1427.
(34) Hebeish, A.; El-Naggar, M.; Fouda, M. M. G.; Ramadan, M. A.; Al-Deyab, S.; El-Rafie, M. Highly Effective Antibacterial Textiles Containing Green Synthesized Silver Nanoparticles. Carbohydr. Polym. 2011, 86, 936.
(35) Li, L.; Au, W.; Hua, T.; Zhao, D.; Wong, K. Improvement in Antibacterial Activity of Moxa Oil Containing Gelatin-Arabic Gum Microcapsules. Text. Res. J. 2013, 83, 1236.
(36) Sundrarajan, M.; Rukmani, A. Durable Antibacterial Finishing on Cotton by Impregnation of Limonene Microcapsules. Adv. Chem. Lett. 2013, 1, 40.
(37) Rodrigues, S. N.; Fernandes, I.; Martins, I. M.; Mata, V. G.; Barreiro, F.; Rodrigues, A. E. Microencapsulation of Limonene for Textile Application. Ind. Eng. Chem. Res. 2008, 47, 4142.
(38) Butstraen, C.; Salaun, F. Preparation of Microcapsules by Complex Coacervation of Gum Arabic and chitosan. Carbohydr. Polym. 2014, 99, 608.
(39) Xiao, Z.; Liu, W.; Zhu, G.; Zhou, R.; Niu, Y. Production and Characterization of Multinuclear Microcapsules Encapsulating Lavender Oil by Complex Coacervation. Flavour Frag. J. 2014, 29, 166.
(40) Yang, Z.; Peng, Z.; Li, J.; Li, S.; Kong, L.; Li, P.; Wang, Q. Development and Evaluation of Novel Flavour Microcapsules Containing Vanilla Oil Using Complex Coacervation Approach. Food Chem. 2014, 145, 272.
(41) Rodrigues, S. N. Microencapsulation of Perfumes for Application in Textile Industry. Ph.D. Dissertation, University of Porto, Portugal, 2010.
(42) Chen, M.; Hu, Y.; Zhou, J.; Xie, Y.; Wu, H.; Yuan, T.; Yang, Z. Facile Fabrication of Tea Tree Oil-Loaded Antibacterial Microcapsules by Complex Coacervation of Sodium Alginate/Quaternary Ammonium Salt of Chitosan. RSC Adv. 2016, 6, 13032.
(43) American Society for Testing and Materials. Standard Test Method for Determining the Antimicrobial Activity of Immobilized Antimicrobial Agents under Dynamic Contact Conditions; ASTM International: West Conshohocken, Pa., 2001; ASTM E2149-01.
(44) Fernandes, I. P.; Amaral, J. S.; Pinto, V.; Ferreira, M. J.; Barreiro, M. F. Development of Chitosan-Based Antimicrobial Leather Coatings. Carbohydr. Polym. 2013, 98, 1229.
(45) Zhang, L.; Que, G. Influence of the HLB Parameter of Surfactants on the Dispersion Properties of Brine in Residue. Colloids Surf, A 2008, 320, 111.
(46) Dong, Z.; Ma, Y.; Hayat, K.; Jia, C.; Xia, S.; Zhang, X. Morphology and Release Profile of Microcapsules Encapsulating Peppermint Oil by Complex Coacervation. J. Food Eng. 2011, 104, 455.
(47) Kunduru, K. R.; Basu, A.; Haim Zada, M.; Domb, A. J. Castor Oil-Based Biodegradable Polyesters. Biomacromolecules 2015, 16, 2572.
(48) Wilson, R; van Schie, B. J.; Howes, D. Overview of the Preparation, Use and Biological Studies on Polyglycerol Polyricinoleate (PGPR). Food Chem. Toxicol. 1998, 36, 711.
(49) Comunian, T. A.; Thomazini, M.; Alves, A. J. G.; de Matos Junior, F. E.; de Carvalho Balieiro, J. C.; Favaro-Trindade, C. S. Microencapsulation of Ascorbic Acid by Complex Coacervation: Protection and Controlled Release. Food Res. Int. 2013, 52, 373.
(50) Rabiskov, M.; Valaskov, J. The Influence of HLB on the Encapsulation of Oils by Complex Coacervation. J. Microencapsul. 1998, 15, 747.
(51) Lakkis, J. M. Encapsulation and controlled release technologies in food systems; Blackwell Publishing: Ames, Iowa, 2007.
(52) Dalmolin, L. F.; Khalil, N. M.; Mainardes, R. M. Delivery of Vanillin by Poly(Lactic-Acid) Nanoparticles: Development, Characterization and In Vitro Evaluation of Antioxidant Activity. Mater. Sci. Eng., C 2016, 62, 1.
(53) Jégat, C.; Taverdet, J. L. Stirring Speed Influence Study on the Microencapsulation Process and on the Drug Release from Microcapsules. Polym. Bull. 2000, 44, 345.
(54) Monllor, P.; Capablanca, L.; Gisbert, J.; Diaz, P.; Montava, I.; Bonet, A. Improvement of Microcapsule Adhesion to Fabrics. Text. Res. J. 2010, 80, 631.
(55) Salaun, F.; Vroman, I.; Elmajid, I. A Novel Approach to Synthesize and to Fix Microparticles on Cotton Fabric. Chem. Eng. J. 201Z 213, 78.
(56) Salaun, F.; Devaux, E.; Bourbigot, S.; Rumeau, P. Thermoregulating Response of Cotton Fabric Containing Microencapsulated Phase Change Materials. Thermochim. Acta 2010, 506, 82.
(57) Liu, J.; Liu, C.; Liu, Y.; Chen, M.; Hu, Y.; Yang, Z. Study on the Grafting of Chitosan-Gelatin Microcapsules onto Cotton Fabrics and its Antibacterial Effect. Colloids Surf, B 2013, 109, 103.
(58) Alonso, D.; Gimeno, M.; Olayo, R.; Vzquez-Torres, H.; Sepulveda-Sánchez, J. D.; Shirai, K. Cross-Linking Chitosan into UV-Irradiated Cellulose Fibers for the Preparation of Antimicrobial-Finished Textiles. Carbohydr. Polym. 2009, 77, 536.
(59) Basch, H.; Gadebusch, H. H. In Vitro Antimicrobial Activity of Dimethylsulfoxide. Appl. Microbiol. 1968, 16, 1953.
(60) Martinez-Camacho, A. P.; Cortez-Rocha, M.; Ezquerra-Brauer, J.; Graciano-Verdugo, A.; Rodriguez-Flix, F.; Castillo-Ortega, M.; Yepiz-Gómez, M. S.; Plascencia-Jatomea, M. Chitosan Composite Films: Thermal, Structural, Mechanical and Antifungal Properties. Carbohydr. Polym. 2010, 82, 305.
(61) Pankey, G. A.; Sabath, L. D. Clinical Relevance of Bacteriostatic versus Bactericidal Mechanisms of Action in the Treatment of Gram-Positive Bacterial Infections. Clin. Infect. Dis. 2004, 38, 864.

What is claimed is:

1. A synthesized aroma-loaded microcapsule having antibacterial activity, comprising:
limonene and vanillin; and
a shell made out of chitosan and gum Arabic, wherein the shell encapsulates the limonene and the vanillin,
wherein the microcapsule has a mean diameter between 10.4 μm and 39.0 μm;
wherein the microcapsule has an encapsulation efficiency between 90.4% and 100%;
wherein the microcapsule does not contain any toxic materials; and
wherein the microcapsule has antibacterial activity.

2. The microcapsule as set forth in claim 1, wherein the microcapsule is grafted onto a textile fabric.

3. A textile fabric grafted thereto the microcapsule as set forth in claim 1.
